(19) United States
(12) Patent Application Publication
(10) Pub. No.: US 2026/0179358 A1
(43) Pub. Date: Jun. 25, 2026

(54) METHOD FOR SPATIAL MAPPING AND EVENT DETECTION IN DYNAMIC ENVIRONMENTS

(71) Applicant: Fauna Robotics Inc, New York, NY (US)

(72) Inventors: Joshua Scott Merel, New York, NY (US); Ana Lynn Pervan, New York, NY (US); Yaswanth Kumar Orru, Jersey City, NJ (US); Silky Arora, New York, NY (US)

(73) Assignee: Fauna Robotics Inc, New York, NY (US)

(21) Appl. No.: 19/411,001

(22) Filed: Dec. 5, 2025

Related U.S. Application Data
(60) Provisional application No. 63/736,930, filed on Dec. 20, 2024.
(60) Provisional application No. 63/735,617, filed on Jan. 6, 2025.

(51) Int. Cl. G06V 10/764; G06F 16/587

(52) U.S. Cl. CPC G06V 10/764; G06F 16/587

(57) ABSTRACT

Some aspects of the present disclosure relate to systems and methods for performing automated tasks using a robotic system in a human-centric environment. According to a first aspect of the present disclosure, hierarchical object identification is used to generate a contextual model of the environment around the robotic system. According to a second aspect of the present disclosure, a semantic understanding of a task is determined in response to a user query. According to a third aspect of the present disclosure, a task-specific controller is used in combination with a general locomotion controller to execute task or sub-task specific processes in connection with completing a query. One or more aspects of the present disclosure may be used in combination with each other and/or may be used with additional systems and processes for performing automated tasks in a human-centric environment.

### CROSS REFERENCE TO RELATED APPLICATIONS

This application claims the benefit of priority under 35 U.S.C. § 119 (e) to U.S. Provisional Patent Application Ser. No. “63/736,930”, filed on Dec. 20, 2024, and entitled “METHOD FOR SEQUENTIAL TASK MANAGEMENT AND VISUOMOTOR POLICY INTEGRATION IN DYNAMIC ENVIRONMENTS,” and to U.S. Provisional Patent Application Ser. No. “63/735,617”, filed on Jan. 6, 2025, and entitled “METHOD FOR SPATIAL MAPPING AND EVENT DETECTION IN DYNAMIC ENVIRONMENTS,” each of which is incorporated by reference herein in its entirety.

### BACKGROUND

Robotic systems use hardware and corresponding software components to control the hardware to provide autonomous, semi-autonomous, or remote control of the robotic system. Robotic systems can be assembled in various form factors depending on the configuration of the robotic hardware. Conventional robotic systems are used in industrial automation and rely on predefined loops to control the robotic system and/or simple decision binaries for providing automated industrial processes. Industrial automation has centered around efficiency of assembly relative to corresponding human workers.

### BRIEF SUMMARY

It is appreciated that industrial automation with robotic systems largely operates in environments without humans in proximity or with defined safe areas where the robotic system does not pose a risk to human operators that may be in the vicinity. In some embodiments, robotic systems are provided that include capabilities and logic that are sensitive to the presence of humans (e.g., in a human-centric environment) to perform work safely within those environments.

Some embodiments provide for a method of generating spatiotemporal maps for use by a robotic system in human-centric environments, the method comprises using a processor to perform: identifying features in an image received from a visual input generated by the robotic system of the environment of the robotic system; estimating relative movement of the robotic system using odometric data received from an inertial measurement unit of the robotic system and the identified features; determining a position of the robotic system based on the relative movement of the robotic system and a previous position of the robotic system; generating a query frame based on the identified features and the determined position of the robotic system; determining a mapping between the query frame and a reference frame; generating a maplet based on the image received from the visual input, wherein the maplet comprises volumetric data based on the image received from the visual input; determining a refined pose of the robotic system based on the estimated movement and a mapping between the query frame and the stored reference frame; determining a revised mapping based on the refined pose, such that applying the revised mapping to the maplet maps the volumetric data to a global coordinate system used by the volumetric map of the environment around the robotic system; and updating the volumetric map to include the volumetric data from the maplet using the revised mapping and storing the query frame as being associated with a corresponding global coordinate associated with the volumetric data from the maplet.

Some embodiments provide for a system, comprising: at least one computer hardware processor; and at least one non-transitory computer-readable storage medium storing processor executable instructions that when executed by the at least one computer hardware processor perform a method of generating spatiotemporal maps for use by a robotic system in human-centric environments, the method comprising: identifying features in an image received from a visual input generated by the robotic system of the environment of the robotic system; estimating relative movement of the robotic system using odometric data received from an inertial measurement unit of the robotic system and the identified features; determining a position of the robotic system based on the relative movement of the robotic system and a previous position of the robotic system; generating a query frame based on the identified features and the determined position of the robotic system; determining a mapping between the query frame and a reference frame; generating a maplet based on the image received from the visual input, wherein the maplet comprises volumetric data based on the image received from the visual input; determining a refined pose of the robotic system based on the estimated movement and a mapping between the query frame and the stored reference frame; determining a revised mapping based on the refined pose, such that applying the revised mapping to the maplet maps the volumetric data to a global coordinate system used by the volumetric map of the environment around the robotic system; and updating the volumetric map to include the volumetric data from the maplet using the revised mapping and storing the query frame as being associated with a corresponding global coordinate associated with the volumetric data from the maplet.

Some embodiments provide for at least one non-transitory computer-readable storage medium storing processor executable instructions that when executed by the at least one computer hardware processor perform a method of generating spatiotemporal maps for use by a robotic system in human-centric environments, the method comprising: identifying features in an image received from a visual input generated by the robotic system of the environment of the robotic system; estimating relative movement of the robotic system using odometric data received from an inertial measurement unit of the robotic system and the identified features; determining a position of the robotic system based on the relative movement of the robotic system and a previous position of the robotic system; generating a query frame based on the identified features and the determined position of the robotic system; determining a mapping between the query frame and a reference frame; generating a maplet based on the image received from the visual input, wherein the maplet comprises volumetric data based on the image received from the visual input; determining a refined pose of the robotic system based on the estimated movement and a mapping between the query frame and the stored reference frame; determining a revised mapping based on the refined pose, such that applying the revised mapping to the maplet maps the volumetric data to a global coordinate system used by the volumetric map of the environment around the robotic system; and updating the volumetric map to include the volumetric data from the maplet using the revised mapping and storing the query frame as being associated with a corresponding global coordinate associated with the volumetric data from the maplet.

Some embodiments further comprise identifying the features in the image, estimating the relative movement of the robotic system, determining the position of the robotic system, generating the query frame, and determining the mapping are executed as front-end process; and determining the refined pose, determining the revised mapping, and updating the volumetric map are executed as back-end processes.

In some embodiments, the front-end processes are executed as high priority processes and the back-end processes are executed as high-computation processes.

In some embodiments, high-priority processes generate an error if executed at a frequency of at less than 5 Hz, and high computation processes may be executed at a frequency of less than 5 Hz without generating an error.

Some embodiments further comprise generating the maplet comprises generating a signed distance field representation of a field of view and associating the maplet with spatial coordinates based on the refined pose.

Some embodiments further comprise updating the volumetric map to include the volumetric data of the maplet comprises using a global optimization technique to position the maplet in the volumetric map relative to existing maplets that have been placed in the map.

In some embodiments, the identified features used to estimate relative movement of the robotic system are the same identified features used to generate the query frame.

In some embodiments, the identified features identified using a trained convolutional neural net configured.

In some embodiments, the identified features used to estimate relative movement of the robotic system are a first set of identified features and the identified features used to generate the query frame are a second set of identified features that is different than the first set of identified features.

Some embodiments provide for a method of processing visual input to identify an object in an environment around a robotic system and classifying the object using a hierarchy of spatiotemporal databases, the method comprises using a processor to: determine a spatial location of a scene captured by the visual input relative to an environmental map of the environment around the robotic system; identify an object in the scene captured by the visual input and determine an attribute associated with the identified object; upon determining the attribute associated with the identified object, determining one or more semantic tokens associated with the determined attribute; update a short-term spatiotemporal database to include the identified object as being; determine whether the identified object matches a stored object associated with a long-term spatiotemporal database, and: upon determining that the identified object does not match a stored object associated with the long-term spatiotemporal database, updating the long-term spatiotemporal database to include the identified object as being associated; and upon determining that the identified object matches a stored object associated with the long-term spatiotemporal database, updating the stored object with the position of the identified object and generating a change log entry for the stored object with a time associated with the visual input.

Some embodiments provide for a system, comprising: at least one computer hardware processor; and at least one non-transitory computer-readable storage medium storing processor executable instructions that when executed by the at least one computer hardware processor perform a method of processing visual input to identify an object in an environment around a robotic system and classifying the object using a hierarchy of spatiotemporal databases, the method comprises using a processor to: determine a spatial location of a scene captured by the visual input relative to an environmental map of the environment around the robotic system; identify an object in the scene captured by the visual input and determine an attribute associated with the identified object; upon determining the attribute associated with the identified object, determining one or more semantic tokens associated with the determined attribute; update a short-term spatiotemporal database to include the identified object as being; determine whether the identified object matches a stored object associated with a long-term spatiotemporal database, and: upon determining that the identified object does not match a stored object associated with the long-term spatiotemporal database, updating the long-term spatiotemporal database to include the identified object as being associated; and upon determining that the identified object matches a stored object associated with the long-term spatiotemporal database, updating the stored object with the position of the identified object and generating a change log entry for the stored object with a time associated with the visual input.

Some embodiments provide for at least one non-transitory computer-readable storage medium storing processor executable instructions that when executed by the at least one computer hardware processor perform a method of processing visual input to identify an object in an environment around a robotic system and classifying the object using a hierarchy of spatiotemporal databases, the method comprises using a processor to: determine a spatial location of a scene captured by the visual input relative to an environmental map of the environment around the robotic system; identify an object in the scene captured by the visual input and determine an attribute associated with the identified object; upon determining the attribute associated with the identified object, determining one or more semantic tokens associated with the determined attribute; update a short-term spatiotemporal database to include the identified object as being; determine whether the identified object matches a stored object associated with a long-term spatiotemporal database, and: upon determining that the identified object does not match a stored object associated with the long-term spatiotemporal database, updating the long-term spatiotemporal database to include the identified object as being associated; and upon determining that the identified object matches a stored object associated with the long-term spatiotemporal database, updating the stored object with the position of the identified object and generating a change log entry for the stored object with a time associated with the visual input.

In some embodiments, the change log entry further comprises specifying if an identified person was associated with the change to the stored object.

In some embodiments, the change log entry further comprises, determining that the stored object is associated with one or more additional identified objects.

In some embodiments, the change log entry further comprises, determining that the stored object is associated with a region of the environmental map.

In some embodiments, identifying the object in the scene captured by the visual input comprises analyzing the visual input using a trained machine learning model to identify the object.

In some embodiments, identifying the object in the scene captured by the visual input comprises analyzing features using a trained machine learning model, wherein the features are generated based on the visual input.

In some embodiments, determining the one or more semantic token associated with the identified object comprises analyzing the identified object using a trained machine learning model configured to identify a plurality of semantic tokens associated with an object and to determine values for the plurality of tokens based on the visual input.

Some embodiments provide for a method of executing motion control of a robotic system using a task specific controller to generate task specific control of motion components, wherein executing the task specific controller comprises: receiving visual input from a visual subsystem of the robotic system; receiving encoder input from a motion subsystem of the robotic system;
selecting a task-specific controller, from a plurality of task specific controllers, based on a user query; processing the visual input and the motion input using the task-specific controller, wherein processing the visual input and the motion input using the task-specific controller comprises processing the visual input and the motion input using a task-specific trained machine learning model to generate task-specific control signals; processing the motion input using a basic motion controller to generate basic motion control signals; and processing the output of the basic motion controller and the output of the task-specific controller to generate control parameters for one or more motion subsystems of the robotic system.

Some embodiments provide for a system, comprising: at least one computer hardware processor; and at least one non-transitory computer-readable storage medium storing processor executable instructions that when executed by the at least one computer hardware processor perform a method of executing motion control of a robotic system using a task specific controller to generate task specific control of motion components, wherein executing the task specific controller comprises: receiving visual input from a visual subsystem of the robotic system; receiving encoder input from a motion subsystem of the robotic system;
selecting a task-specific controller, from a plurality of task specific controllers, based on a user query; processing the visual input and the motion input using the task-specific controller, wherein processing the visual input and the motion input using the task-specific controller comprises processing the visual input and the motion input using a task-specific trained machine learning model to generate task-specific control signals; processing the motion input using a basic motion controller to generate basic motion control signals; and processing the output of the basic motion controller and the output of the task-specific controller to generate control parameters for one or more motion subsystems of the robotic system.

Some embodiments provide for at least one non-transitory computer-readable storage medium storing processor executable instructions that when executed by the at least one computer hardware processor perform a method of executing motion control of a robotic system using a task specific controller to generate task specific control of motion components, wherein executing the task specific controller comprises: receiving visual input from a visual subsystem of the robotic system; receiving encoder input from a motion subsystem of the robotic system;
selecting a task-specific controller, from a plurality of task specific controllers, based on a user query; processing the visual input and the motion input using the task-specific controller, wherein processing the visual input and the motion input using the task-specific controller comprises processing the visual input and the motion input using a task-specific trained machine learning model to generate task-specific control signals; processing the motion input using a basic motion controller to generate basic motion control signals; and processing the output of the basic motion controller and the output of the task-specific controller to generate control parameters for one or more motion subsystems of the robotic system.

In some embodiments, processing the visual input and the encoder input using the task-specific trained machine learning model to generate task-specific control signals comprises: processing the visual input with a first task-specific trained machine learning model to output attention areas for the robotic system; and processing an output of the first task-specific trained machine learning model and the encoder input using a second task-specific trained machine learning model to generate task-specific control signals.

In some embodiments, processing the motion input using the basic motion controller to generate basic motion control signals comprises processing the motion input using a basic motion trained machine learning model to output basic motion control signals.

In some embodiments, prior to processing the visual input using the first task-specific trained machine learning model, the visual input is converted to a heigh scan grid based in part on a pose of the robotic system, received as the encoder input.

In some embodiments, a depth mapper model is used to generate a height scan grid by processing a depth image received as the visual input, a root orientation of the robotic system received from the encoder input, and the pose of the robotic system received from the encoder input.

In some embodiments, the pose of the robotic system specifies a neck pose and a pelvis pose of the robotic system.

In some embodiments, a volumetric mapping is used to generate a height scan grid by processing the pose of the robotic system and the visual input.

In some embodiments, the pose of the robotic system is estimated using the visual input and the encoder input.

In some embodiments, processing the output of the general trained machine learning model and the output of the second task-specific trained machine learning model to generate control parameters comprises using a fusion model to process the output of the general trained machine learning model and the output of the second task-specific trained machine learning model.

In some embodiments, the first task-specific trained machine learning model is a convolutional neural network.

In some embodiments, the second task-specific trained machine learning model is a multilayer perception model.

### BRIEF DESCRIPTION OF DRAWINGS

Various aspects and embodiments of the application will be described with reference to the following figures. It should be appreciated that the figures are not necessarily drawn to scale. Items appearing in multiple figures are indicated by the same reference number in all the figures in which they appear.

FIG. 1A illustrates robotic processing environment 100 for orchestrating the operation of a robotic system, in accordance with some embodiments described herein.

FIG. 1B illustrates an example of the robotic processing environment 100 including submodules that may be used by the robotic system to provide efficient functionality for executing a diverse range of processes, in accordance with some embodiments described herein.

FIG. 2 is an illustration of an example robotic system 200, in accordance with some embodiments described herein.

FIG. 3 illustrates a flow chart of process 300 for generating a spatiotemporal map using a robotic system, in accordance with some embodiments described herein.

FIG. 4A illustrates an example of a trained machine learning model used for feature identification, in accordance with some embodiments described herein.

FIG. 4B illustrates an example of a machine learning model trained for visual place recognition, in accordance with some embodiments described herein.

FIG. 4C illustrates an example of a specialized data structure that may be used for efficient matching of the outputs with query frames.

FIG. 4D illustrates an example of a deep neural network with an adaptive computational structure for matching query frames to reference frames, in accordance with some embodiments described herein.

FIG. 5A illustrates an example implementation of a system for generating a spatiotemporal map, in accordance with some embodiments described herein.

FIG. 5B illustrates a loop closure process for providing continuity in an arrangement of maplets for a volumetric map, in accordance with some embodiments described herein.

FIG. 6 illustrates an example of process 600 for identifying and storing object data in accordance with some embodiments described herein.

FIG. 7A illustrates an example of process 700 for generating one or more tasks for execution by a robotic system in response to receiving a user query, in accordance with some embodiments described herein.

FIG. 7B illustrates a process 710 for identifying whether a user query is associated with a stored object in a hierarchical object memory, in accordance with some embodiments described herein.

FIG. 8 illustrates an example method 800 for executing motion control of a robotic system using a task specific controller to generate task specific control of motion components, in accordance with some embodiments described herein.

FIG. 9A illustrates an example implementation of process 800 configured for direct observation, in accordance with some embodiments described herein.

FIG. 9B illustrates an example embodiment of a task-specific controller 902, in accordance with some embodiments described herein.

FIG. 9C illustrates a second example implementation of process 800 configured for direct observation, in accordance with some embodiments described herein.

FIG. 9D illustrates an example implementation of process 800 configured for robot centric observation, in accordance with some embodiments described herein.

FIG. 10 illustrates example applications of the systems and methods described herein in connection with a package delivery event, in accordance with some embodiments described herein.

FIG. 11 illustrates example applications of the systems and methods described herein in connection with responding to a user query, in accordance with some embodiments described herein.

FIG. 12 illustrates example applications of the systems and methods described herein in connection with task-specific controllers, in accordance with some embodiments described herein.

FIG. 13 illustrates an illustrative implementation of a special purpose computer system 1300, that may be specially programmed to improve over conventional systems, to be used in connection with any of the embodiments of the disclosure provided herein

### DETAILED DESCRIPTION

### I. Introduction

Some aspects of the present disclosure relate to systems and methods for performing automated tasks using a robotic system in a human-centric environment. According to a first aspect of the present disclosure, hierarchical object identification is used to generate a contextual model of the environment around the robotic system. According to a second aspect of the present disclosure, a semantic understanding of a task is determined in response to a user query. According to a third aspect of the present disclosure, a task-specific controller is used in combination with a general locomotion controller to execute task or sub-task specific processes in connection with completing a query. One or more aspects of the present disclosure may be used in combination with each other and/or may be used with additional systems and processes for performing automated tasks in a human-centric environment.

Despite decades of innovation in automation technologies, there are still many challenges that inhibit the development of robotic systems for operation in human-centric environments. In particular, existing development has focused on robotic systems for industrial applications or for specific niche functionality. The inventors have recognized and appreciated that safe operation, efficient logic processing, and power management remain barriers to the development of robotic systems for operation in human-centric environments.

Unlike robotic systems designed for industrial applications which may be large and powerful enough to cause serious damage to property or persons, robotic systems for operation in human-centric environments need to be able to operate safely around people. The inventors have recognized and appreciated that when designing robotic systems for human-centric environments, form factors that are compatible with navigating shared spaces with humans such as homes, commercial areas, and/or public spaces provide limitations on the size of the robotic system. Therefore, hardware or processes that might be well suited for use in an industrial environment may be inappropriate in human-centric spaces.

According to some aspects of the technology described herein, operating in human-centric environments may require anthropogenic reasoning. Anthropogenic reasoning includes not just the identification of objects or people but a contextual understanding of how those objects may relate to other objects and/or how those objects may relate to people. For example, determining which areas of a room are used for ingress or egress may be critical so that the robotic system does not place objects in the way of people walking around the environment. As another example, distinguishing between different coats and associating them with their owner may be required to correctly execute a task involving retrieving an individual's coat.

Additionally, unlike industrial environments, which have well defined protocols for the flow of people and objects, human-centric environments are prone to changes in arrangement, changes in the preferences of how the people who occupy the space use the space, and may have multiple people occupying the space with different personal property and preferences. Thus, the inventors have recognized and appreciated that additional context about objects and people in the environment around the robot, as well as how they relate to each other, (e.g., anthropogenic reasoning), may be required to execute processes correctly in human-centric environments. Furthermore, in addition to anthropogenic reasoning, responding to specific queries may require a situational understanding about the person who is making the request.

Unlike industrial environments, where robotic systems may be tasked with certain discrete tasks as part of a larger process, human-centric environments are generally smaller and thus are restricted in how many different specialized robotic systems may fit. Accordingly, the inventors have recognized and appreciated that the versatility required in executing tasks in a human-centric environment may be dramatically different from the highly specialized processes performed in an industrial environment. While there are some robotic systems that operate in human-centric environments, such systems are specialized to specific functionality like vacuuming or network control of network connected smart appliances. However, these highly specialized systems are not compatible with versatile multi-task completion. For example, a robotic system equipped with a vacuum has no mechanism for grabbing objects, opening doors or containers, or navigating stairs.

In order to execute processes in a human-centric environment one of more processes for navigation, interaction, transportation, identification, context of queries, and anthropomorphic reasoning may be required. To be able to successfully execute these processes across a variety of different human-centric environments, e.g., different residences, public spaces, commercial spaces, or a mixture of each, requires versatile hardware and software modules that can adapt processes to the actual environment of the robotic system.

The inventors have recognized and appreciated that hardware and software modules which can adapt processes to the actual environment of the robotic system provide additional challenges for implementing robotic systems because of the added computational power required. In particular, more complex models may be required to successfully perform processes across a variety of different environments. However, more complex models require additional computational resources and increase power consumption, both of which provide challenges for implementing on-board solutions with robotic system. In contrast, cloud computed solutions have increased flexibility for computational resources and power draw, but introduce significant delay between data acquired by the robotic system that must then be sent to the server for analysis before sending back instructions for executing a process by the robotic system. Even small latency delays may be prohibitive, especially for locomotion or fine motor control used in precision processes.

Finally, power consumption is one of the most limiting restraints in compute power and in hardware operability. Robotic systems for use in human-centric environments should have enough power to successfully complete tasks without needing to interrupt the task for charging or swapping between power supplies. Accordingly, processes should use power conservatively to increase the operational time of a single charge or power supply.

Accordingly, the inventors have developed systems and methods examples of which are described below in connection with the figures to address the challenges described above.

### II. Robotic System

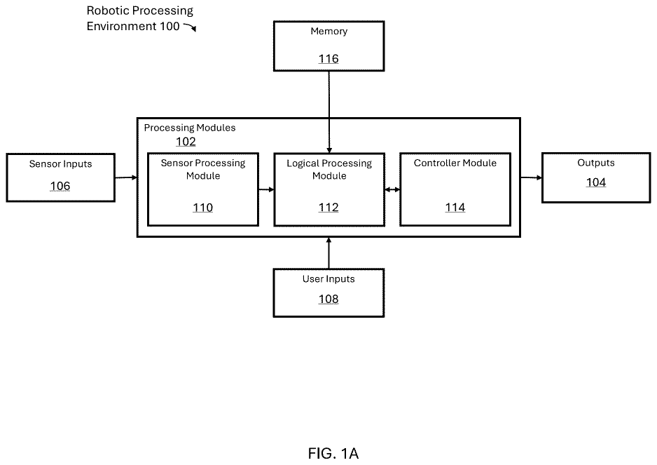

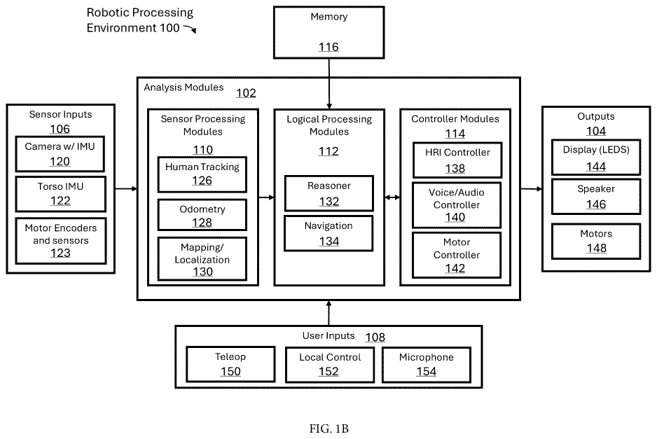

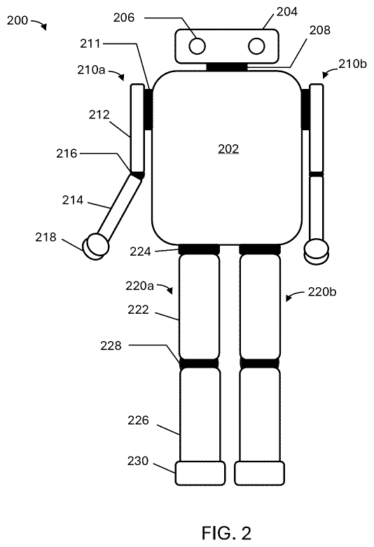

An example robotic system for implementing aspects of the technology described herein in human-centric environments is shown in FIG. 1A, FIG. 1B, and FIG. 2.

FIG. 1A illustrates robotic processing environment 100 for orchestrating the operation of a robotic system, in accordance with some embodiments described herein. Robotic processing environment 100 includes processing modules 102 for interfacing with and controlling the physical hardware of the robotic systems. Additionally, processing modules 102 may execute analysis processes in connection with operation of the robotic system for executing routines or completing queries. Robotic processing environment 100 inputs sensor inputs 106, user inputs 108, and outputs 104.

Processing modules may include separate modules that may execute different routines using separate modules that can operate in parallel with specialization such that their respective functions are executed efficiently (e.g., with low latency and reduced power cost per task). In the illustrated example of FIG. 1A, the processing modules include sensor processing module 110, logical processing module 112, and controller module 114.

Sensor processing modules 110 may process the data received from sensor inputs 106 to convert the data stream into easy to process tokens. The sensor processing modules may use the data stream, or the resulting tokens, to update models and/or directories used by the robotic system. Alternatively, or additionally, the sensor processing modules may generate specific tokens, based on the data stream, for use by logical processing module 112.

Logical processing module 112 is responsible for executive reasoning, such as identifying tasks for execution by the robotic system and selecting routines, parameters for constraining the routines, cost functions for evaluating the routine execution, and other logic-based processes. The logical processing module 112 may access memory 116 for referencing one or more databases maintained by the robotic system. In some processes, the logical processing module 112 may select a routine and designate another module or hardware subsystem to execute the routine.

The logical processing module may receive inputs from instructions stored in memory 116, reference data stored in memory 116, live data directly from sensor inputs 106, processed live data from sensor processing module 110, and user inputs 108. The user inputs 108 may be facilitated by controller module 114 which may process the data received directly from the user input and may generate tokens, representative of the user input, for processing by the logical processing module 112.

The use of sensor processing module 110 and controller module 114 for generating tokens from the inputs received by sensors or users, respectively, may simplify the processing executed by the logical processing module. Accordingly, the sensor processing module and controller module may increase computation efficiency of intensive logical processes by reducing the complexity of the input data used in the logical analysis.

Additionally, controller module 114 may convert tokens output from the logical processing module into specific data streams for controlling the hardware systems and subsystems of the robotic system. The controller module 114 may provide that data stream through outputs 104.

Processing modules 102 receive sensor inputs 106 from the hardware sensors of the robotic system. The processing modules 102 may also receive user inputs 108 that include specific instructions for directly controlling the robot. Additionally, or alternatively, the user inputs may be queries that controller modules 114 process to generate a semantic understanding of the query which is then further processed by the logical processing modules 112 to identify and execute tasks that answer or respond to the query.

Although described at a general level with respect to FIG. 1A, the inventors have recognized and appreciated that the specific efficiency of process execution, and the corresponding modules used therein, may be highly process dependent. Accordingly, for specific processes, a specific subset of modules may be used to work in concert with each other to accurately and efficiently complete the task. Since one module may be actively used by several processes at once, each individual process may impact other processes being executed for basic or background tasks. Accordingly, each process should be designed so as not to disrupt the general functioning or its ability to maintain multiple active tasks that may be needed for responding to a single query.

FIG. 1B illustrates an example of the robotic processing environment 100 including submodules that may be used by the robotic system to provide efficient functionality for executing a diverse range of processes, in accordance with some embodiments described herein. The analysis modules 102 may receive different specific sensor inputs 106 depending on the process being executed. The robotic system may have different sensor subsystems that may separately communicate sensor data streams for use by the analysis modules 102. In the illustrated example of FIG. 1B, sensor inputs 106 include a camera with inertial measurement unit (IMU) 120, a torso IMU 122, motor encoders and sensors 123.

The camera with IMU 120 input may include input from any imaging system suitable for determining or approximating distances. For example, the imaging system may be stereo cameras, a time-of-flight sensor(s), a structured light scanner, and/or lidar. The camera with IMU 120 is not limited to having a single imaging system, the camera with IMU 120 input may include multiple visual systems. For example, stereo cameras may be configured for capturing images in front of a head sub-system of the robotic system while multiple time-of-flight sensors may be arranged around the robotic system to capture proximity measurements in each direction around the robotic system. As another example, the camera with IMU 120 may include a single imaging system such as a stereo camera.

Additionally, the camera with IMU 120 input may include IMU measurements that provide data on the pose of the robotic system and by extension the position of the camera of the robotic system. For example, the camera may be installed in a head subsystem that includes actuators to rotate and tilt the head subsystem to aim the camera in different directions around the robotic system.

Torso IMU 122 input may include IMU measurements that provide data on the pose of the torso of the robotic system. For example, as will be discussed in greater detail with reference to FIG. 2, the robotic system may include a torso unit to which arm, leg, and head subsystems are attached. The torso IMU input 122 may provide data on the overall pose of the robotic system.

Motor encoders and sensors 123 may include signals related to movement and/or load of the robotic system. Encoders may provide signals related to the position of actuators of the robotic system. For example, an arm subsystem may include several actuators positioned in different joints of the arm subsystem (e.g., shoulder, elbow, wrist, manipulator) encoders may provide signals corresponding to the position of the actuators and by extension, the position of the arm subsystem. Additionally, sensors such as temperature sensors may be configured to detect the temperature of the actuators in the robotic system. The temperature of an actuator is related to the load or stress upon the actuator. Thus, the temperature sensors may be used to determine a load upon an arm subsystem of the robotic subsystem. Although the provided examples describe actuators in an arm subsystem, a person of skill in the art would understand that other subsystems of the robotic system may generate signals from respective encoders and sensors that would be included with motor encoders and sensor input 123.

With respect to analysis modules 102, sensor processing modules 110 may include submodules for tracking humans 126, odometry 128, and environmental mapping 130. The human tracking submodule 126 may process sensor inputs 106 to detect and store actions of, or interactions with, people around the robotic system. Odometry submodule 128 may process sensor inputs 106 to determine a position of the robotic system based on data from the leg subsystems of the robotic system. Environmental mapping may generate a map of the area around the robotic system.

In some embodiments, the sensor processing modules 110 submodules may receive outputs from one or more other submodules. For example, odometry module 128 may receive camera with IMU input 120 and torso IMU 122 to determine odometric based position. The odometric based position may be provided to mapping and localization submodule 130 along with the unprocessed camera with IMU input 120 and torso IMU 122 data such that the mapping and localization submodule 130 generates a map of the area around the robotic system.

The mapping and localization submodule 130 may receive output from the odometry submodule 128 to determine a position of the robotic system relative to the environment around it. The mapping and localization submodule may provide the position of the robotic system to the navigation submodule 134 which may generate instructions for the controller modules 114 to perform specific actions or processes connected with movement of the robotic system around the environment.

Logical processing modules 112 may include submodules for logical reasoning 132 and navigation 132. The logical reasoning submodule 132 may generate high level commands for execution by the robotic system that then may be processed into execution signals by controller submodules. In some embodiments, the logical reasoning submodule may be used to execute aspects of the methods described herein.

Controller modules 114 may include submodules for human-robot interaction 138, voice/audio processing 140, motor movement 142. Human-robot interaction submodule 138 may interface with outputs 104 to communicate messages to users. For example, human-robot interaction submodule 138 may interface with display LEDs 144 and/or speaker 146 to communicate visual and/or audio messages to users, respectively. Voice/audio submodule 140 may use natural language processing to process audio inputs and to generate semantic audio outputs. For example, voice/audio submodule 140 may receive user input through microphone 154 and may output semantic audio responses generated using speaker 146.

Motor submodule 142 may generate signals for controlling movement of the robotic system through motor output 148. Motor submodule 142 may receive instructions for executing movement of the robotic system from logic reasoning submodule 132 or navigation submodule 134. The motor submodule 142 may generate signals for controlling actuators to cause movement of the robotic system.

In some embodiments, user inputs may directly interface with motor submodule 142 to remotely pilot the robotic system. For example, motor submodule may receive directional movement instructions from a controller communicatively coupled with the robotic system through local network connections. In some embodiments, a Bluetooth connection may be used to connect local controller 152 to motor controller 142. As another example, teleoperation submodule 150 may receive instructions from a remote location through a network connection, such as the Internet. Teleoperation submodule 150 may allow users to remotely connect to the robotic system to provide movement instructions for the robotic system.

Although illustrated as separate subsystems and submodules, a person of ordinary skill in the art would understand that implementations of the robotic system are not limited to the specific separation of components and modules described herein. In some implementations, certain modules or subsystems may be combined or further separated into designated submodules, as aspects of the technology described herein are not limited in this respect.

FIG. 2 is an illustration of an example robotic system 200, in accordance with some embodiments described herein. Robotic system 200 is assembled with a humanoid form factor. Accordingly, the robotic system includes a torso unit 202 with a head unit 204 that is connected to the torso unit through neck coupling 208. Robotic system 200 further includes limb units such as arm units 210a and 210b and leg units 220a and 220b for manipulation and locomotion. Arm units 210a and 210b may be connected to torso unit 202 through shoulder couplings 221. Similarly, leg units 220a and 220b may be connected to torso unit 202 through leg/hip couplings 224.

Head unit 204 includes a vision subsystem for providing visual inputs to the robotic system. The vision subsystem may include cameras or sensors for acquiring depth information of the area around the robotic system. In the illustrated embodiment of FIG. 2, the vision subsystem includes a stereo depth camera that uses a binocular vision system 206. Binocular vision system 206 is positioned on the front of the head unit giving the appearance of eyes. In some embodiments, additional sensors may be included in the vision system such as time-of-flight sensors and/or LIDAR sensors. The additional sensors may be embedded in the head unit and/or embedded in other units such as the torso unit 202.

Neck coupling 208 includes one or more actuators for moving the head unit 204 relative to torso unit 202. The one or more actuators may provide movement along multiple axes, for example by rotating and tilting to change the field of view of the vision subsystem. In some embodiments, neck coupling 208 includes two actuators for providing rotation and tilting of head unit 204.

Torso unit 202 includes one or more actuators for moving limbs relative to the torso or moving the torso relative to the limbs. In some embodiments, torso unit 202 includes an actuator for each arm unit 210a and 210b configured at a shoulder coupling between the arm units and the torso to rotate the arm units relative to the torso. In some embodiments, torso unit 202 includes an actuator between the torso unit and the couplings of the leg units, such that the torso unit can be rotated, relative to the legs, without requiring movement of the legs.

Arm units 210a and 210b include multiple components linked through articulatable couplings. In the illustrated embodiment of FIG. 2, an arm unit includes an upper arm portion 212, a lower arm portion 214, and a gripper 218. The upper arm portion 212 is connected to the torso unit 202 through shoulder coupling 211, and the upper arm portion 212 is connected to the lower arm portion 214 through elbow coupling 216. The gripper 218 is connected to the end of lower arm portion 214.

The arm unit may include multiple actuators in the articulatable couplings between the arm unit components such that the arm can be moved along multiple axis of rotation at each of the articulatable couplings. For example, the arm unit may include multiple actuators adjacent to the shoulder coupling to tilt and rotate the arm unit relative to the shoulder coupling 211. The elbow coupling 216 may include multiple actuators to tilt and rotate the lower arm portion 214 relative to the upper arm portion 212. Additionally, multiple actuators may be configured between gripper 218 and lower arm portion 214 to tilt and rotate the grippers relative to the lower arm portion 212. Finally, one or more actuators may be included in the grippers to enable the gripper to pick up, release, or otherwise interact with objects.

Additionally, leg units 220a and 220b include multiple components linked through articulatable couplings. In the illustrated embodiment of FIG. 2, a leg unit includes an upper leg portion 222, a lower leg portion 226, and a foot 230. The upper leg portion 222 is connected to torso unit 202 through leg/hip coupling 224, and the upper leg portion 222 is connected to the lower leg portion 226 though knee coupling 228. The foot 230 is connected to the end of lower leg portion 226.

The leg unit may include multiple actuators in the articulatable couplings between the leg unit components such that the leg can be moved along multiple axes of rotation at each of the articulatable couples. For example, the leg unit may include multiple actuators in the leg coupling to tilt and rotate the leg unit relative to the torso unit 202. The knee coupling 228 may include multiple actuators to tilt and rotate the lower leg portion 226 relative to the upper leg portion 222. Additionally, multiple actuators may be configured between foot 230 and lower leg portion 226 to tilt and rotate the foot relative to the lower leg portion.

In some embodiments, additional actuators or other means of producing motion of the robotic components may be included in foot 230 to adjust positions of components in the foot as the robotic system moves.

The actuators described in connection with FIG. 2 may be implemented using any suitable type of actuators that is rated for the power, load, and speed requirements of the robotic system.

### III. Spatiotemporal Mapping

As described above, the robotic system may use a spatiotemporal map in connection with navigating the environment around the robotic system as well as in the planning and execution of other processes within the environment. Spatiotemporal maps include both spatial and temporal data such that the map can register and record changes to the environment around the robotic system and the spatial position associated with a change is preserved. The inventors have recognized and appreciated generation of spatiotemporal maps using edge computing of resources integrated with a robotic system provides specific challenges for efficiently and accurately determining the position of the robotic system relative to its surroundings. Although described in the context of edge computed processes, aspects of processes that do not require low latency or real-time responsiveness may be computer using network connected resources with the results being communicated to the robotic system.

Accordingly, the inventors have developed systems and methods for generating spatiotemporal maps that integrate identifiable features that can provide sufficient detail for high confidence determination of spatial relationships with a volumetric map that provides efficient processing. To provide continuity for the spatiotemporal maps, as the robotic system navigates around the environment resulting in multiple perspectives of a same location in the environment, the inventors have developed loop closing processes, in accordance with some embodiments described herein.

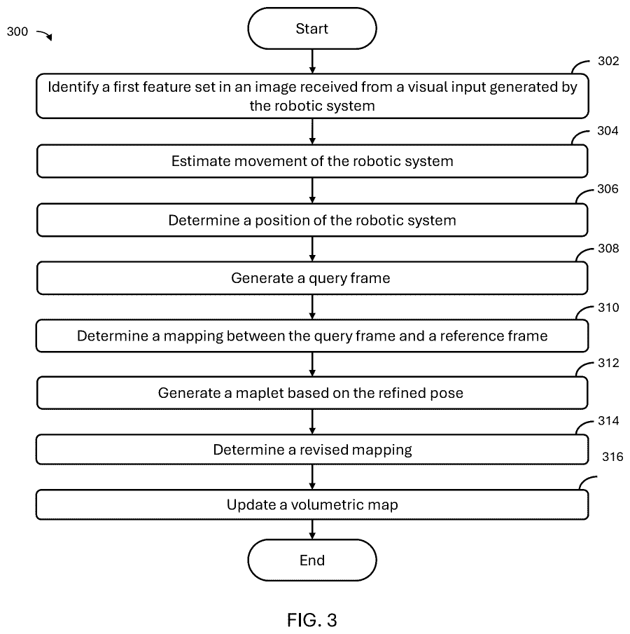

FIG. 3 illustrates a flow chart of process 300 for generating a spatiotemporal map using a robotic system, in accordance with some embodiments described herein. Prior to the start of process 300, the robotic system may acquire images from a vision subsystem and inertial measurements from an inertial measurement unit. Process 300 may be executed by a computer processor integrated with a robotic system and configured to execute processor executable instructions stored in non-volatile memory. In some embodiments, the robotic system is used to execute process 300 as an edge computing process.

Process 300 starts at act 302 by identifying a first feature set in an image received from a visual input generated by the robotic system. The image received from the visual input of the robotic system may be any suitable image format. Nonlimiting examples of suitable visual inputs include images captured by an RGB camera sensor, a depth camera, monochromatic camera sensors, a charge-coupled device (CCD) sensor, a complementary metal-oxide semiconductor (CMOS) image sensors, line scan sensors, or other cameras configured for machine vision capabilities. Such visual input sensors may be embedded in the head and/or body of a robotic system, such as the robotic system discussed above in connection with FIG. 2.

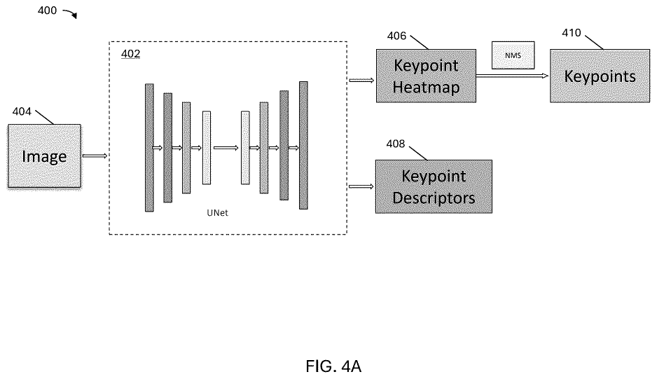

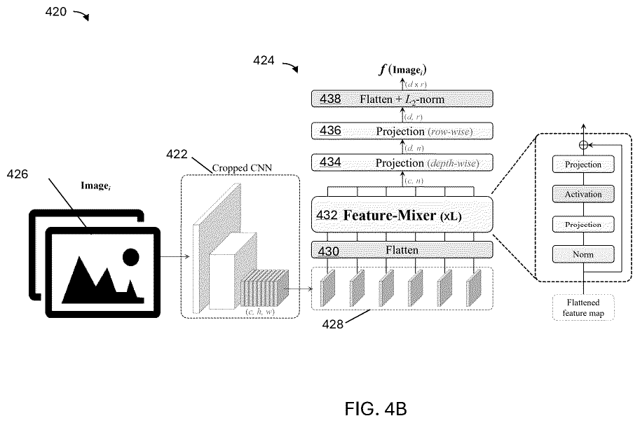

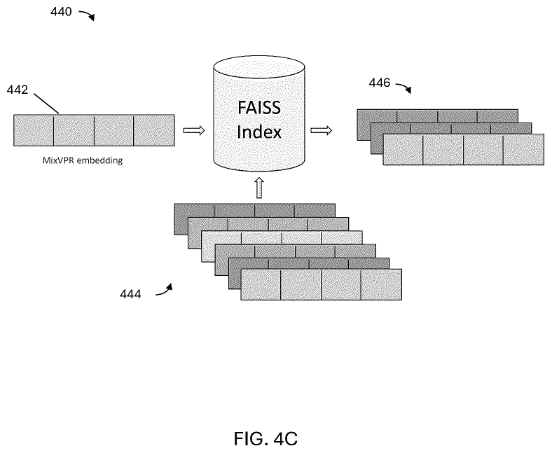

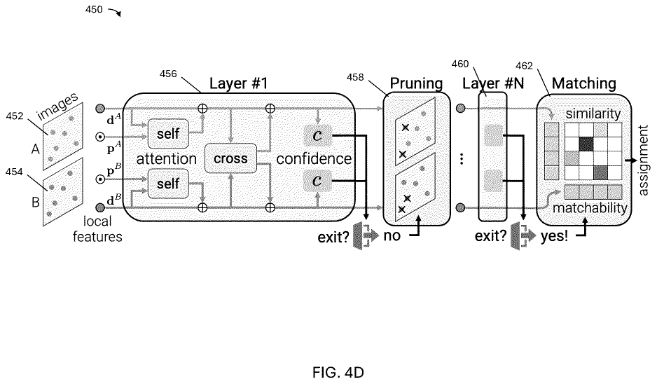

Returning to the discussion of FIG. 3, the first feature set is identified in an image received from a visual input generated by the robotic system of the environment of the robotic system using a machine learning model trained for machine vision, in accordance with some embodiments described herein. The trained machine learning model may be any machine learning model configured to identify features indicative of the objects or shapes in the field of view of an image. For example, the trained machine learning model may be a compiler system configured for dynamic shape recognition such as the example shown in FIG. 4A. Although described in connection with a compiler system, other methods of feature extraction may be used such as other convolutional neural networks, one-stage detectors such as the You Only Look Once models, edge detection algorithms used with support vector machines, and other feature extraction methods as aspects of the technology described herein are not limited in this respect.

Process 300 continues at act 304 by estimating movement of the robotic system. In some embodiments, estimating movement of the robotic system uses odometric movement received from an IMU and the first feature set identified in act 302. The odometric data may include inertial measurements that are used to estimate a spatial offset relative to a previous position. Additionally, or alternatively, the robotic system may use identified features from the image received from the visual input to estimate a spatial offset. Rather than relying on odometric data, some embodiments may use encoder signals indicative of the positions or changes in positions of components of the robotic system as an estimate of the movement and position of the robotic system. In some embodiments, encoder signals may be used in combination with other odometric data such as inertial measurements. As another example, the spatial offset of the robotic system may be estimated using any visual-inertial odometric technique, as aspects of the technology described herein are not limited in this respect.

In some embodiments, the odometric data may be used to estimate a relative pose of the robotic system. The relative pose may include an orientational offset of the robotic system relative to a previous pose. The relative pose of the robotic system may be used to estimate a field of view of the robotic system. Accordingly, different poses of the robotic system may result in different identified features even when the robotic system is in a same or similar location in which the robotic system identified other feature points.

At the conclusion of act 304, the robotic system may have produced multiple estimates of the movement of the robotic system that were generated using different inputs, or combinations of inputs, from the sensors of the robotic system. In some embodiments, the movement of the robotic system may be estimated using multiple techniques or processes such that the robotic system generates two or more estimates of the movement relative to a previous position of the robotic system.

Process 300 continues at act 306 by determining a position of the robotic system. In some embodiments, the multiple estimates of the movement of the robotic system are used to determine a position of the robotic system. In some embodiments, heuristic rules may be applied to create a hierarchy for prioritizing different estimates of the movement to resolve discrepancies between the different estimates. In some embodiments, fusion models may be used to fuse the multiple estimates to provide a more accurate determination of the position of the robotic system. For example, an Extended Kalman Filter (EKF) may be used to fuse the multiple estimates and to output an estimate of the position and the pose of the robotic system.

Process 300 continues at act 308 by generating a query frame. In some embodiments, a query frame is generated based on the identified features and the determined position of the robotic system. Accordingly, the query frame represents the features in view by the robotic system from a particular location. In some embodiments, the keyframe further comprises a temporal signature such that the query frame represents the features in view by the robotic system at a particular time.

Process 300 continues at act 310 by determining a mapping between the query frame and a reference frame to generate a refined pose of the robotic system. The query frame may be matched with a reference frame to identify the position of the robotic system relative to a previous position. The query frame may be matched with a reference frame that includes a same or similar field of view of the environment around the robotic system. After the query frame and reference frame are identified as including the same or similar field of view, the differences in the perspectives of the field of view can be used to generate a mapping that is proportional to the difference between the current position of the robotic system and the position of the robotic system when the reference frame was captured.

Matches between the query frame and a reference frame of the robotic system may use a library of reference frames, the estimate of the movement of the robotic system, and/or a subset of recently acquired reference frames. In some embodiments, matches between the query frame and the reference frame are determined by searching a database of reference frames for potential matches, and then further analyzing the potential matches to determine which reference frame corresponds to a same or similar field of view as the query frame.

To provide a database of reference frames for potential matches, the image received from the visual input generated by the robotic system may be encoded and stored in a database. Accordingly, a received image may be processed using the same encoding and compared to previously captured frames represented in the database. In some embodiments, the encoding may generate a representation of the frame that provides efficient comparison and matching processes. A copy of the unencoded image may also be stored, such that the encoded representation may be used to identify a potential match, and then the unencoded image may be provided to a different model for a more detailed comparison. The more detailed comparison does not require the unencoded image. In some embodiments, a differently encoded image may be stored in association with the encoded image. When a potential match is identified with the encoded image, the differently encoded image may be provided to a different model for the more detailed comparison.

The encoding of frames may be performed using a trained machine learning model that generates representations indicative of a place shown in a field of view of an image. In some embodiments, a machine learning model trained for visual place recognition may be used to process images. The output of the visual place recognition model may be a general description that is representative of the features in the image. An example implementation is discussed below in connection with FIG. 4B.

In some embodiments, the encoded output from the machine learning model trained for visual place recognition may be stored in a specialized data structure for efficient matching of the outputs with query frames. To compare query frames to the entries in the specialized data structure, the query frames are first processed to generate an encoded version that is then processed by a matching process against the entries in the specialized data structure. The matching process may return multiple results representing potential matches between the query frame and multiple previously stored frames. An example implementation is discussed below in connection with FIG. 4C.

For potential matches between the query frame and previously stored frames, the unencoded or differently encoded images are provided as reference frames for further comparison with the query frame. In the further comparison, potential matches between query frames and reference frames are used to determine a spatial offset and/or relative pose of the robotic system. In some embodiments, the matches between query frames and reference frames compare features from the query frame with those in the reference frame to generate a quantitative determination of the degree of matching between the two frames. In some embodiments, a deep neural network with an adaptive computational structure for reducing computational processing time is used to determine the degree of matching. In some embodiments, algorithmic processes may be used to determine the degree of matching.

From the matched result, a mapping is generated between the query frame and the reference frame that corresponds to a difference in position between the robotic system when it captured the query frame and the robotic system when in captured the reference frame. An example implementation is discussed below in connection with FIG. 4D.

A refined pose of the robotic system is determined using the mapping between the query frame and the reference frame. In some embodiments, determining the refined pose of the robotic system uses the matched query and reference frames to determine a spatial offset and/or pose of the robotic system. In some embodiments, a transformation is determined between features in the query frame and the corresponding matched features in the reference frame. The resulting transformation is used to determine the spatial relationship between the present position and/or pose of the robotic system relative to the position and/or pose of the robotic system when it acquired the reference frame. The resulting spatial relationship represents the refined pose of the robotic system.

Process 300 continues at act 312 by generating a maplet based on the refined pose. The maplet is a volumetric spatial representation of the portion of the environment around the robotic system that is captured in the visual input. In some embodiments, the volumetric spatial representation is generated using signed distance fields (SDFs). As discussed herein, SDFs may provide for fast frame processing time. For example, the frame processing time may provide between 40 and 300 frames per second, between 60 and 250 frames per second, or between 100 and 200 frames per second.

Process 300 continues at act 314 by determining a revised mapping. Determining a revised mapping of the system uses the refined pose of the system to check for any loop closures based on the relative pose of the query frame compared to the reference frame. In some embodiments, the features of the query frame and their relative positions are analyzed with the features of the reference frame.

In some embodiments, outlier points are removed prior to determining the revised mapping. Outlier points may be removed using a consensus algorithm. For example, a Random Sample Consensus (RANSAC) model may be used to iteratively determine points that are not related to the mapping between the query frame and the reference frame.

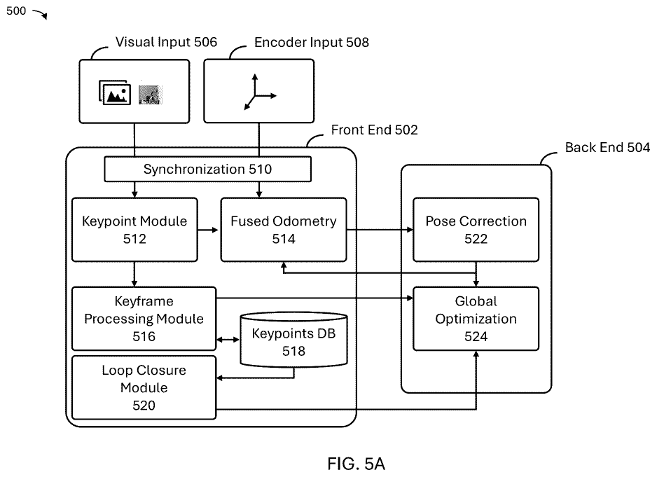

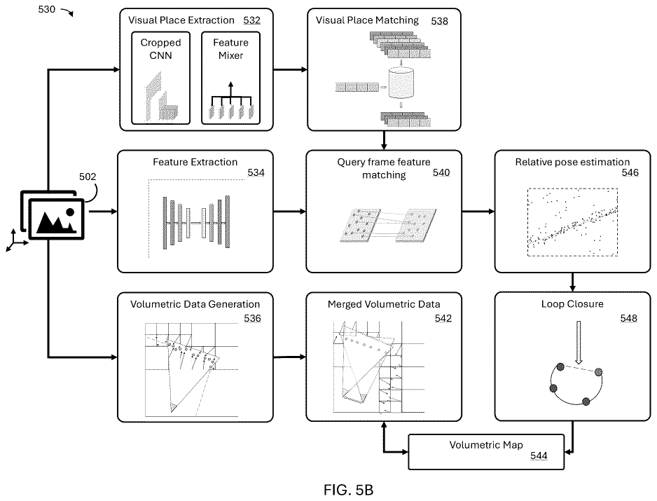

Once outliers are removed, a graph optimization may be used to determine the revised mapping. In some embodiments, the graph optimization may group data captured from a same room or an observable area into a maplet based on data collected from multiple keyframes. Each keyframe may be considered a node of the graph optimization in combination with the positional data of the robotic system. The graph optimization may include edges that correspond to maplets and further determine edges that relate each maplet to a global reference frame. Accordingly, during optimization, the graph optimization may determine edges between keyframes from different maplets that indicate a discontinuity in the positioning of the maplets relative to each other. Based on that discontinuity, a mapping may be generated to correct the discontinuity thereby closing any open loops in an environmental map comprised of the maplets. The graph optimization is discussed further in connection with FIG. 5B below.

Process 300 continues at act 316 by updating a volumetric map. In some embodiments, the volumetric map may also store volumetric data as an SDF. Accordingly, the incoming depth frames used to generate the maplet may be added to or merged with the volumetric map based on the determined revised mapping. For example, if the revised mapping determined that there was a closed loop between the query frame and a reference frame, then the maplet is positioned within the volumetric map to connect two previously unconnected portions of the volumetric map. However, if the revised mapping determined that there was no closed loop between the query frame and the reference frame, the maplet is aligned to a common surface or object represented in the volumetric maps. Accordingly, the maplet extends the volumetric map by adding previously unincluded volumetric data.

As another example, it may be determined that the revised mapping corresponds to an existing portion of the volumetric map. In this instance, the maplet may be used to determine whether there have been any changes in the corresponding portion of the volumetric map. As discussed further herein, those changes may be recorded in a change log for use with responding to user queries.

Following act 316, process 300 concludes. After the conclusion of process 300, the volumetric map may be used by other processes executed by the robotic system, such as navigation and/or responding to user queries. In some embodiments, process 300 may be executed on a loop such that the robotic system continually updates the volumetric map of the environment around the robotic system.

The inventors have recognized and appreciated that executing process 300 iteratively (e.g., in a loop) may not require sequential execution of acts 302-316. Rather, feature extraction may be executed more frequently, and volumetric processing may be executed less frequently. Accordingly, the iterative execution of process 300 may execute a portion of process 300 as front-end processes and the remaining portion of process 300 as back-end processes. An example implementation of process 300 executed using a combination of front-end and back-end processes is provided in FIG. 5A below. Examples of specific models that may be used in connection with process 300 are provided in FIGS. 4A-4D below.

FIG. 4A illustrates an example of a trained machine learning model used for feature identification, in accordance with some embodiments described herein. The trained machine learning model 400 used for feature identification includes a convolutional neural network (CNN) 402 for processing image input 404 to output keypoint heatmap 406 and keypoint descriptions 408. The keypoint heatmap 406 is further processed to obtain keypoints 410.

In some embodiments, CNN 402 is implemented using a fully convolutional neutral network. For example, CNN 402 may be implemented using a UNet architecture. The keypoint heatmap 410 produced by the CNN may be further processed using non-maximum suppression to generate specific keypoints 410 based on the keypoint heatmaps 406.

In some embodiments, trained machine learning model 400 may be implemented using a DISK model, as described in Zhu, Kai, et al. “DISC: A Dynamic Shape Compiler for Machine Learning Workloads,” arXiv, 2021, which is incorporated by reference herein in its entirety.

FIG. 4B illustrates an example of a machine learning model trained for visual place recognition, in accordance with some embodiments described herein. As shown in FIG. 4B, the trained machine learning model 420 includes a cropped CNN 422 for processing image 426 and a feature mixing model 424 for producing a simplified output from the features identified by the cropped CNN 422. The cropped CNN 422 outputs feature maps 428 which are flattened by flattening layer 430 before being processed by feature mixer 432. The feature mixer 432 includes projection, activation, and normalization layers. Two projection layers 434 and 436 reduce the dimensionality of the output from feature mixer 432. Finally, a flatten layer 438 reshapes the output of the model.

In some embodiments, trained machine learning model 420 may be implemented using a Mix VPR architecture, as described in Ali-bey, Amar, et al. “MixVPR: Feature Mixing for Visual Place Recognition,” IEEE Xplore, which is incorporated by reference herein in its entirety.

FIG. 4C illustrates an example of a specialized data structure 440 that may be used for efficient matching of the outputs with query frames. As shown in FIG. 4C an input reference frame encoded using the MixVPR encoding described in FIG. 4B can be searched against previously indexed frames 444 to output comparisons 446 between the encoded vector 442 and the indexed vectors of frames 444. For example, the data structure may provide for dot product vector comparison or other techniques for vector comparison.

In some embodiments, the specialized data structure stores dense vectors that are clustered according to an inverted file index. In some embodiments, the specialized data structure may be a FAISS index, as described in Douze, Matthijs, et al. “The Faiss Library,” arXiv, 2024, which is incorporated by reference herein in its entirety.

FIG. 4D illustrates an example of a deep neural network with an adaptive computational structure for matching query frames to reference frames, in accordance with some embodiments described herein. Deep neural network 450 includes first transform layer 456 for processing features from a query frame 452 and features from a reference frame 454. First transform layer 456 includes self-attenuation layer, cross attenuation layer, and a confidence layer. If the confidence layer provides a high confidence match 462, the model may exit the process flow without continuing analysis.

Following first transform layer 456, a pruning layer 458 removes keypoints from consideration that fail to match. After pruning, additional transform layers 460 are included which may be structured similarly to the first transform layer 456. Transform layers 460 may include additional pruning layers. The output of deep neural network 450 includes matched features from the two analyzed images and a matching score.

In some embodiments, the deep neural network may be a LightGlue model, as described in Lindenberger, Philipp, et al. “LightGlue: Local Feature Matching at Light Speed,” which is incorporated by reference herein in its entirety.

FIG. 5A illustrates an example implementation of a system for generating a spatiotemporal map, in accordance with some embodiments described herein. System 500 includes front-end process 502 and back-end process 504 that operate with different priorities for computational resources such that front-end processes 502 are executed more frequently than back-end processes 504. In some embodiments, the front-end processes 502 execute feature extraction and the back-end processes 504 execute volumetric processing.

In some embodiments, front-end processes 502 are executed at a rate of 5 Hz or faster and back-end processes are executed with a rate of 5 Hz or slower. In some embodiments, front-end processes 502 are executed at a rate of 10 Hz or faster and back-end processes are executed with a rate of 10 Hz or slower. In some embodiments, front-end processes 502 are executed at a rate of 15 Hz or faster and back-end processes are executed with a rate of 15 Hz or slower. In some embodiments, the rate of execution of the front-end processes and the back-end processes may be variable depending on the availability of the computational resources of the system. Accordingly, when the execution rate drops below the intended execution rate, an error is generated for error handling by the robotic system.

In the illustrated example of FIG. 5A, visual input 506 and encoder input 508 are received from the robotic system. The visual input and encoder input may be received as sensor inputs from the robotic system such as sensor inputs 106 described above in connection with FIGS. 1A and 1B. The visual input may be generated by a binocular vision system such as the vision system described above in connection with FIG. 2. The encoder input 508 may be generated by an IMU such as the torso IMU, a head IMU, or a combination of IMUs, also described above in connection with FIG. 2. In some embodiments, visual input 506 may include any visual input that captures depth measurements in the field of view.

A synchronization module 510 synchronizes the timing between the visual input 506 and encoder input 508 such that subsequent processing of the visual and encoder inputs can be associated with data captured at a same time and in a same position of the robotic system. Keypoint module 512 processes the visual input to extract features, as described herein. The extracted features from keypoint module 512 are provided to a fused odometry system 514 and keyframe processing module 516.

Fused odometry system 514 receives the keypoint output from module 512 and the synchronized encoder input 508 to generate a pose estimate of the robotic system. The fused odometry module may use the features from keyframe output in combination with the encoder input to execute a visual inertial odometry (VIO) process to estimate a pose of the robotic system. Additionally, or alternatively, the fused odometry module may also execute a legged odometry process that generates an estimate of a pose of the robotic system using forward kinematics and IMU data. Additionally, or alternatively, the fused odometry module may also execute an IMU pre-integration process to combine multiple IMU measurements into a reduced factor for smoother processing. In some embodiments, an EKF module processes two or more of the outputs from the VIO process, legged odometry, and IMU pre-integration to generate a more accurate pose estimate than may otherwise be produced by relying on just a single pose estimate technique.

Keyframe processing module 516 receives the keypoint output from module 512. In some embodiments, keypoint module 512 may generate one set of keypoints (e.g., features) for each frame of a visual input received, and that set of keypoints may be provided to both the fused odometry module 514 and the keyframe processing module 516. However, in some embodiments, the keypoint module 512 may generate different sets of keypoints representing different feature extraction processes for each frame of a visual input received. One set of keypoints may be provided to fused odometry 514 and the second set may be provided to keyframe processing module 516. In this configuration, the different sets of keypoints may be specialized for the different processes executed by the respective modules which receive the output. Keyframe processing module 516 compares the keypoints for a received frame of visual input 50 (e.g., a query frame) with keypoints computed for reference frames stored in a specialized data structure 518 to determine a match between the query frame and the reference frame that may be used in visual place identification.

Loop closure module 520 also uses the keypoints computed for reference frames stored in the specialized data structure 518 to determine loop closures to be used in the back end global optimization to ensure continuity in the arrangement of maplets to generate the volumetric maps of the system. The loop closure module 520 may be implemented using the methods described above in connection with process 300 and shown in the example illustrated in FIG. 5B below.

The outputs from front-end modules 502 are provided to back-end modules 504 for volumetric processing. As shown in FIG. 5A, the output of the used odometry module 514 is provided to a pose correction module 522. Pose correction module 522 generates a refined pose by comparison of the pose estimate with a mapping between the query frame and the reference frame to refine the pose estimate of the system. The refined pose is provided to a global optimization unit 524 for generating the volumetric map of the system. In some embodiments, the refined pose of the system is provided back to the fused odometry system 514 to improve the accuracy of the EKF pose estimation.

FIG. 5B illustrates a loop closure process for providing continuity in an arrangement of maplets for a volumetric map, in accordance with some embodiments described herein. Input signals 530 include visual inputs and encoder inputs that are provided to a visual place extraction module 532, feature extraction module 534, and volumetric data generation module 536.

Volumetric data generation module 536 generates maplets using signed distance fields, as described herein. Although, in other implementations, other spatial representations may be used as aspects of the technology described herein are not limited in this respect. The maplets represent three-dimensional data of the environment around the robotic system. Accordingly, the maplets represent a map of the environment around the robotic system that may be combined with other maplets to generate a larger map of the environment available to the robotic system. The larger map may represent all the areas the robotic system has navigated or may be organized by particular buildings and/or locations. For example, the larger map may represent the map of a house or apartment and each maplet may correspond to a particular room. In some embodiments, maplets may be computed from one or more keyframes. In some embodiments, maplets may correspond to a grouping of spatial data extracted from multiple keyframes that share an easily identifiable feature. Accordingly, maplets may correspond to high-confidence groupings between spatial data extracted from different frames. In such embodiments, spatial data that cannot be grouped with a high confidence with other extracted spatial data will instead be used to create a new maplet. The new maplet may be positioned relative to the first and the positioning further refined as described herein.

The maplets generated by volumetric data generation module 546 are merged with existing maplets from a volumetric map 544 of the environment for the robotic system by volumetric merging data module 542.

The visual place extraction module 532 may be implemented using any suitable feature extraction model. The visual place extraction module 532 extracts features that may be used to identify a place captured within the field of view by comparison to reference images. As an example, the visual place extraction model may be implemented using the trained machine learning model described above in FIG. 4B. The extracted features are provided to a database for use in visual place matching. The extracted features may also be indexed in the database with the image from which the features were extracted.

A visual place matching module 538 searches previously extracted features that are stored in the database for potential matches with the extracted features received from visual place extraction model 532. As an example, visual place matching module may be implemented using the database described above in connection with FIG. 4C. In other examples, any searchable database may be used in connection with visual place matching.

Potential matches from the visual place matching module are provided to a query frame feature matching module 540. The query frame feature matching module 540 also receives features from feature extraction module 534 to determine an actual match with received visual input 530. The feature extraction module 534 may also process the stored images from the potential matches. In some embodiments, the potential matches may be processed by feature extraction module 534 once they are identified as potential matches. In some embodiments, the potential matches may have been previously processed by feature extraction model 534 and the extracted features stored in the database. Thus, when a potential match is made, the previously extracted features may be provided to query frame feature matching module 540.

In some embodiments, the feature extraction module 534 may extract the same features as visual place extraction module 532. In such embodiments, the modules 532 and 534 may be implemented as a single module. In other embodiments, the feature extraction module 534 may extract different features from visual place extraction module 532. In such embodiments, modules 532 and 534 may have a same or a different architecture. When a same architecture is used, the models are trained or configured to extract different types of features from input images. When different architectures are used, the models may be trained with the same images. However, other training schemes and model architectures may be used as aspects of the technology described herein are not limited in this respect.

An actual match determined by query frame feature matching 540 is provided to a relative pose estimation module 546. Relative pose estimation module 546 estimates a pose of the robotic system using the matched image from the query frame feature matching module. For example, the relative pose estimation module 546 may determine a mapping between matched feature points received from input signals 530 and matched feature points in the reference image, as determined by query frame feature matching 540. In some embodiments, a pose estimate of the robotic system is also used to improve the relative pose estimation by relative pose estimation module 546.

The estimate pose is provided to loop closure module 548 to merge duplicated positional data that is misaligned. Variance in the positional determination of the robotic system may result in positional data that corresponds to a single spatial location being recorded at two different locations. Loop closure module 548 identifies and merges these points to improve the accuracy of a volumetric map 544 of the environment around the robotic system.

In some embodiments, the loop closure module 548 uses a graph optimization to merge the spatial location data. Nodes of the graph optimization may include a six-degree of freedom depiction of the pose of the robotic system including position and orientation as well as the pose of the visual input sensor (e.g., robotic systems camera or vision components) and maplet origin poses. Edges in the graph optimization represent spatial constraints between the nodes.

In some embodiments, the graph optimization may include nodes for a global frame (e.g., for the entire environmental map), nodes for maplet frames (e.g., the point of reference used when generating the maplet), and nodes for a keyframe (e.g., the spatial data collected from a single point. Accordingly, the graph optimization may output correlations between nodes that improve the positioning of maplets together to make a larger map by improving the accuracy a mapping between nodes that are associated with different maplets. The optimized poses generated by loop closure model 548 are used to revise the position of maplets in volumetric map 544 to improve the accuracy of the environmental map.

### IV. Hierarchical Object Identification and Storage

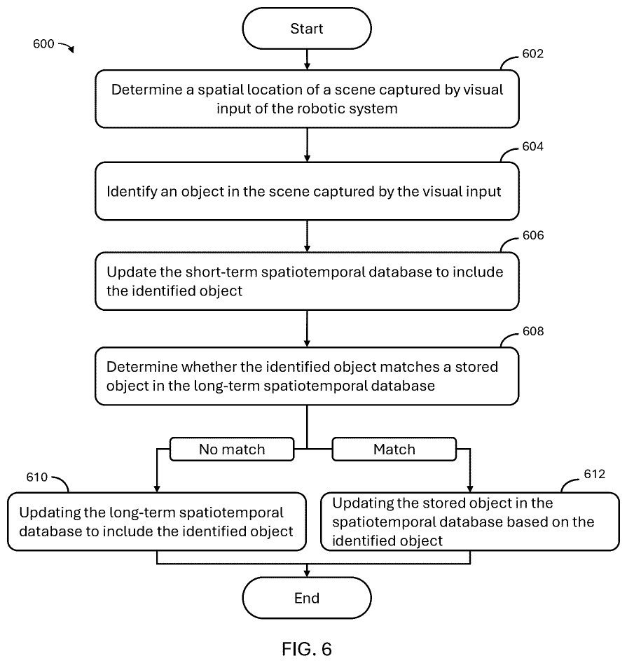

As discussed above, generating a contextual model of the environment around a robotic system provides challenges. To improve object identification and contextual model building by the robotic system, the inventors have developed hierarchical systems and methods for identifying and storing data acquired for objects around the robotic system. FIG. 6 illustrates an example of process 600 for identifying and storing object data in accordance with some embodiments described herein.

Prior to the start of process 600, the robotic system may generate an environmental map of the area around the robotic system. In some embodiments, the environmental map may be a volumetric map generated using a loop closure process, such as process 300 described above in connection with FIG. 3.

Process 600 starts at act 602 by determining a spatial location of a scene captured by visual input of the robotic system. The spatial location of the scene is determined relative to an environmental map of the area around the robotic system. In some embodiments, determining the spatial location may use the methods and models described above to determine the position of the robotic system in connection with FIG. 3.

Process 600 continues at act 604 by identifying an object in the scene captured by the visual input. The object may be identified using a machine learning model trained for object identification. For example, a CNN or a You Only Look Once (YOLO) model may be used for object identification. Other machine vision models for object identification may be used as aspects of the technology described herein are not limited in this respect.

For each identified object, the process determines an attribute associated with the identified object. The attribute of the object may specify the type of object. For example, different attributes may be associated with different properties of interest about the object. An article of clothing may have properties of interest related to the identity of a user who typically wears the clothing, the type of weather in which the clothing is typically worn, and default instructions for handling the clothing. A piece of furniture may have properties of interest related to whether the furniture is expected to be moved when it is interacted with, such as a chair. A package may have properties of interest related to the size, weight, sender, delivery time, carrier, etc.

In some embodiments, the attributes associated with an identified object are stored in a database of attributes for each class of objects. The database may be pre-populated with typical objects encountered in human-centric environments. In some embodiments, the database may be populated based on user queries by creating new attributes in response to instructions from or interactions with a user. For example, if a user provides a query about an object to the robotic system that the robotic system had not previously encountered, the robotic system may update the database attributes associated with the identified object to include terms associated with the query. In the specific example of a package, a user may query the robotic system whether the package was delivered in good condition. If this is a query previously unencountered by the robotic system, the database attributes associated with the identified object may be updated to include a package condition at time of delivery property. Additionally, the robotic system may prompt the user for feedback associated with their query, by prompting the user to classify a package a condition that the robotic system may use as training data to aid in evaluating the condition of future packages.

Process 600 continues at act 606 by, upon determining the attribute associated with the identified object, determining one or more semantic tokens associated with the determined attribute. The semantic tokens represent the specific value for the attributes determined in act 604. In some embodiments, the semantic tokens may correspond to natural language labels for the specific values of the attributes.

Process 600 continues at act 608 by updating a short-term spatiotemporal database to include the identified object. The short-term spatiotemporal database represents the objects in the environment around the robotic system. In some embodiments, the short-term spatiotemporal database may represent objects that are currently within the field-of-view of the system and objects that were within the field-of-view of the system during the current session of operation. Sessions of operation may be based on calendar days, portions of the day (e.g., morning, afternoon, night), a specific time duration, or until a triggering action occurs. Triggering actions may include charging, entering a power conservation mode, resolution of all outstanding user queries, etc. In some embodiments, the short-term spatiotemporal database may represent objects that are within the current field-of-view of the system.

The short-term spatiotemporal database includes the location of the object relative to an environmental map of the area around the robotic system and includes the time of observation of the location of the object. In some embodiments, the short-term spatiotemporal database may be formatted as a layer of bounding boxes overlaid on the environmental map. In some embodiments, the short-term spatiotemporal database may be formatted as structured or unstructured data that includes the spatial data, the temporal data, an attribute and/or semantic tokens.

Process 600 continues at act 610 by determining whether the identified object matches a stored object in the long-term spatiotemporal database. The long-term spatiotemporal database represents the objects the robotic system has encountered. In some embodiments, the long-term spatiotemporal database may include all objects from within a given time period. For example, the given time period may be a week, a month, six months, one year, or a time period specified by the user. In some embodiments, the long-term spatiotemporal database represents all the objects the robotic system has encountered

The long-term spatiotemporal database may have the same formatting as the short-term spatiotemporal database with the exception that the long-term spatiotemporal database retains objects in the database for a longer period of time. In this way, the long-term spatiotemporal database may represent a memory of where objects are when they are outside of a field-of-view of the robotic system or may represent a memory of where objects were last known to be.

Upon determining that no match exists in the long-term spatiotemporal database, process 600 continues to act 610 where the long-term spatiotemporal database is updated to include the identified objection.

Upon determining that a match does exist in the long-term spatiotemporal database, process 600 continues to act 612 where the attributes of the stored object are compared to the attributes of the identified object. If there are differences between the attributes of the stored object and the attributes of the identified object, the attributes of the stored object are modified to match those of the identified object.

If the attributes of the stored object are updated to match those of the identified object, a change log entry is created specifying the object entry that was changed. In some embodiments, the change log entry includes the attribute changed and the previous attribute value. Accordingly, previously identified attributes of an object are historically tracked and may be relied upon when responding to user queries.

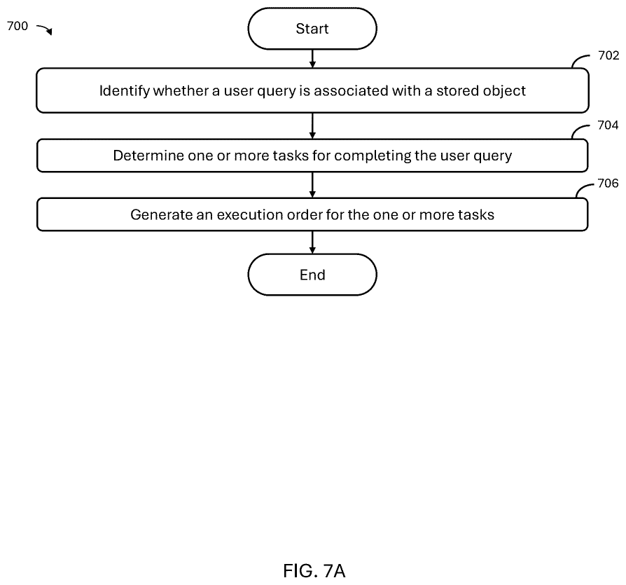

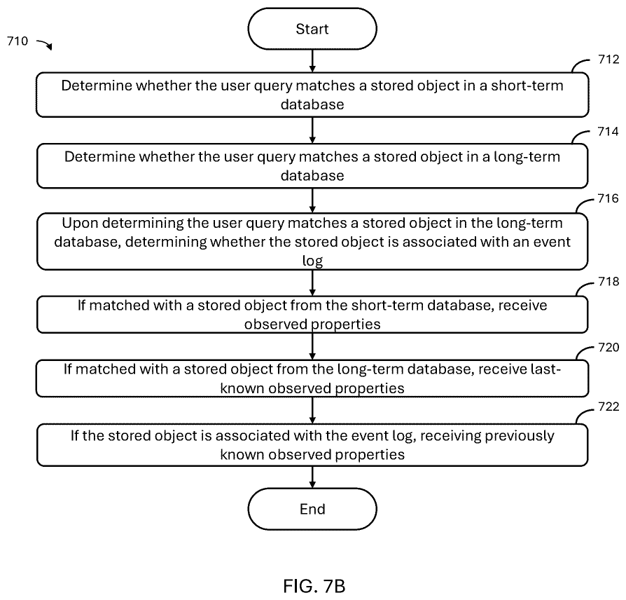

FIG. 7A illustrates an example of process 700 for generating one or more tasks for execution by a robotic system in response to receiving a user query, in accordance with some embodiments described herein. Prior to the start of process 700, the robotic system may receive a user query. In some embodiments, the user query is received through audio instruction recorded by a microphone of the robotic system. The recorded audio may be interpreted using a large language model (LLM) to develop a semantic understanding of the query.

Process 700 starts at act 702 by identifying whether a user query is associated with a stored object. Some user queries may ask a question about an object or may ask the robotic system to execute an action on an object. For example, a query that asks a question about an object may ask the robotic system to provide information about the object. As another example, a query that asks the robotic system to execute an action on an object may ask the robotic system to move, manipulate, retrieve, or otherwise interact with the object. Not every query submitted to the robotic system may be associated with a stored object, some queries may involve specific directions or requests for information about the environment. For example, inquiries about the weather, indoor temperature, time, news, messages, etc.

Accordingly, in some embodiments, act 702 analyzes a semantic analysis of a user query to determine whether it is associated with a stored object. For example, an LLM may be used to analyze the user query to determine if it is requesting the robotic system to provide information about or an interaction with a stored object. In other embodiments, the user may be able to query the robot about the object directly through specific registered commands.

In some embodiments, the semantic analysis of the user query may be processed by an LLM. The user query may be received from a speech-to-text module that receives audio from a microphone of the robotic system and converts the audio into text that is then input into the LLM to generate semantic outputs. For example, the LLM may receive the text representative of the user query and may be guided by one or more prompts to generate outputs representing a semantic understanding of the user query.

Although described in connection with an LLM, other language analysis models may be used, as aspects of the technology described herein are not limited in this respect.

Process 700 continues at act 704 by determining one or more tasks for completing the user query. The robotic system determines one or more tasks for completing the user query by searching a hierarchical database for matches related to objects referenced by the user query. The robotic system may use the matches in the hierarchical database to determine spatiotemporal properties and/or attributes for the objects referenced by the user query that may be used to determine the one or more tasks for completing the user query. For example, the robotic system may use matches in the hierarchical database to determine the location of an object, the last known location of the object, a previous location of the object, how to handle the object, and other observable properties of the object. In some embodiments, determining the one or more tasks for completing the user query may use a hierarchical database as described in process 710, as shown in FIG. 7B.

Some user queries may request information about the object, for such queries, the robotic system may determine an information look up task and a response task. Some queries may request an action taken with respect to the object, for such queries, the robotic system may use a current location to determine a navigation task to navigate to the location of the object and a manipulation task to interact with the object.

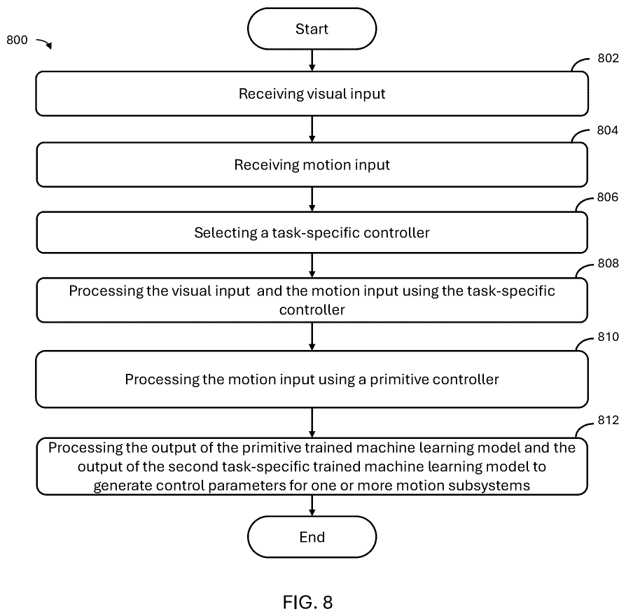

Process 700 continues at act 706 by generating an execution order for the one or more tasks. The execution order of the one or more tasks may be a sequential ordering of the different tasks to be executed by the robotic system to complete the user query. The robotic system may include separate controllers for executing different tasks. Accordingly, the order of execution of the one or more tasks may include queuing multiple controllers to be executed in order. As an example, retrieving an object may include the tasks of locating the object, grabbing the object, navigating while carrying the object, and placing the object. Each of the tasks may be controlled by a different high level controller that generates signals to be processed by sub-system controllers that generate control signals for controlling the subsystems of the robot. As the robot completes one task, such as locating the object using a navigation controller, it may transition to executing a grab task using a controller for controlling the arm and gripper of the robotic system. An example of using task specific controllers is provided in process 800 shown in FIG. 8.

The inventors have recognized and appreciated that a hierarchical object memory structure may improve the performance of a robotic system by providing efficient storage of object properties for recall during task execution. FIG. 7B illustrates a process 710 for identifying whether a user query is associated with a stored object in a hierarchical object memory, in accordance with some embodiments described herein. Prior to the start of process 710, trained machine learning models may analyze a user query to determine a semantic understanding of the query that may be represented as one or more semantic tokens. Semantic tokens may represent the context, relationships, and meaning of the query that indicate the underlying intent.

Process 710 starts at act 712 by determining whether the user query matches a stored object in a short-term database. The short-term database may include entries that correspond to objects identified in the environment around the robotic system. In some embodiments, the short-term database may include entries that correspond to the objects in the same room as the robotic system which have been identified from the robotic systems field of view. The robotic system may move the subsystem in which the vision subsystem is configured to capture different fields of view of the room to accurately survey the objects around the robotic system.

In some embodiments, the short-term database of the robotic system may be associated with a specific time duration and may remove entries from the short-term database when that object hasn't been identified in a field of view of the robotic system within the time duration, as described above in connection with FIG. 6

Process 710 continues at act 714 by determining whether the user query matches a stored object in a long-term database. The long-term database may include entries that correspond to all observed objects that the robotic system has identified, both presently in the present environment, previously observed in the present environment, or previously observed in other environments. The entries may correspond to the most recent properties observed for the stored object.

Process 710 continues at act 716 by, upon determining the user query matches a stored object in the long-term database, determining whether the stored object is associated with an event log. As described in connection with act 714, the long-term database may reflect the most recent/last know values for the properties of a stored object. The event log may represent each of the previous values for the stored object as well as a time stamp corresponding to when the properties changed. In this way, the event log may represent the previously known properties of a stored object.

Process 710 continues at act 718, if the user query is matched with a stored object from the short-term database, by receiving observed properties for the stored object from the short-term database.

Process 710 continues at act 720, if the user query is matched with a stored object from the long-term database, by receiving last known properties for the stored object from the long-term database.

Process 710 continues at act 722, if the stored object is associated with the event log, by receiving previously known observed properties for the stored object from the event log. In some embodiments, entries in the event log related to the specific user query may be received. For example, if the user query involves knowledge from a particular time, only entries related to the stored object and that time may be returned. However, in other embodiments, all entries in the event log related to the specific user query may be received.

After act 722, process 710 concludes. Following the conclusion of process 710, the observed properties, last known properties, and/or previously known observed properties may be used by the robotic system to respond to queries about the object.

### V. Task Specific Controllers for Task Execution by Robotic Systems

The inventors have recognized and appreciated that the task specific controllers can efficiently and accurately generate control signals for particular tasks that may be used to modify basic motion controls. Basic motion controls may represent a movement of the robotic system in a representation that can be scaled to produce different actions. For example, a locomotion basic motion may include poses that cause the robotic system to move leg subsystems to propel the robotic system forward in a walking motion. The locomotion basic motion may be modified by a task specific controller for running in which the length of the stride, velocity of actuators in the leg subsystems, and the angle a foot portion of the leg subsystem are modified from the locomotion basic motion. Similarly, the locomotion basic motion may be modified by a task specific controller for climbing stairs in which the leg subsystems lift the foot portions higher in each stride and shorten the stride length to correspond to the spacing between stairs. The robotic system may include a library of basic motion controls and a library of task specific controllers that may be selected for execution in response to a user query.

Additional nonlimiting examples of task specific controllers may include opening doors, lifting objects, carrying objects while walking, manipulating tools, placing an object on shelves or in cabinets, folding laundry, etc. Each subsystem of the robotic system may include one or more basic motion controls corresponding to movements of the subsystem. Additional nonlimiting examples of basic motion controls may include moving a head subsystem, arm motions, gripper motions, leg motions, torso motions, etc.

FIG. 8 illustrates an example process 800 for executing motion control of a robotic system using a task specific controller to generate task specific control of motion components, in accordance with some embodiments described herein. Prior to the start of process 800, a user query may be received and processed using the method described herein.

Process 800 begins at act 802 by receiving a visual input of the robotic system. In some embodiments, the visual input may be received as sensor inputs from the robotic system such as sensor inputs 106 described above in connection with FIGS. 1A and 1B. The visual input may be generated by a binocular vision system such as the vision system described above in connection with FIG. 2, as described herein. Any suitable visual input that provides depth information about the field of view of the robotic system may be received and used in connection with process 800.

Process 800 continues at act 804 by receiving motion input of the robotic system. The motion input includes signals generated by the robotic system that correspond to the movement or position of the robotic system. In some embodiments, the motion input includes signals from an IMU. The IMU signals may be generated by a torso IMU, a head IMU, or multiple IMUs such as both a torso IMU and a head IMU.

In some embodiments, the motion input includes encoder signals corresponding to encoders associated with actuators that control movement of the robotic system. In some embodiments, the motion input includes both signals from an IMU and the encoder signals.

In some embodiments, the motion input may be received as sensor inputs, similar to the visual inputs, from the robotic system such as sensor inputs 106 described above in connection with FIGS. 1A and 1B, as described herein.

Process 800 continues at act 806 by selecting a task-specific controller from a plurality of task specific controllers, based on a user query. The robotic system selects a task-specific controller to execute a specific task. For example, when the robotic system arrives at a staircase and a next task for the robotic system to complete a user query involves ascending or descending the staircase, then the robotic system may select a stair climbing task specific controller.

In some embodiments, task-specific controllers are selected based on the visual input from the robotic system. For example, when the robotic system identifies a staircase as being directly in front of the robotic system, then the robotic system may execute a stairclimbing specific controller. As another example, when the robotic system identifies a closed door in front of the robotic system, then the robotic system may execute a door-opening specific controller.

Process 800 continues at act 808 by processing the visual input using the task-specific controller. Processing the visual input and the motion input using the task-specific controller includes processing the visual input and the motion input using a task-specific trained machine learning model to generate task-specific control signals. The robotic system processes the visual input using a task-specific trained machine learning model to generate task-specific control signals.

Process 800 continues at act 810 by processing the encoder input using a basic motion controller. In some embodiments, the basic motion controller is a basic motion trained machine learning model that outputs control signals in response to the current pose of the robotic system and an action motion. The basic motion trained machine learning model produces control signals for generic motions of the robotic system and does not rely on the specific environment of the robotic system. For example, the action motion may be moving the leg subsystems of the robotic system for locomotion of the robotic system. In some embodiments, the current pose of the robotic system may include motor positions, velocities, root orientation, and/or angular velocity.

Unlike the processing in act 808, the processing in act 810 may be done blind, e.g., without using the visual input of the robotic system.

Process 800 continues at act 812 by processing the output of the basic motion trained machine learning model and the output of the task-specific trained machine learning model to generate control parameters for one or more motion subsystems. The processing modifies the basic motion control signals based on the analysis of the actual conditions around the robotic system to produce modified control signals based both on the generic motion of the robotic system and real-time modifications responding to the actual conditions around the robotic system. In some embodiments, a fusion module is used to fuse the output of the task-specific trained machine learning model and the basic motion trained machine learning model.

Following act 812, the control signals may be sent to respective controllers to control the motion of the robotic system. Process 800 may execute iteratively to continuously select the appropriate task-specific controller and to execute the task-specific controller to generate control signals to respond to the real time conditions around the robotic system.

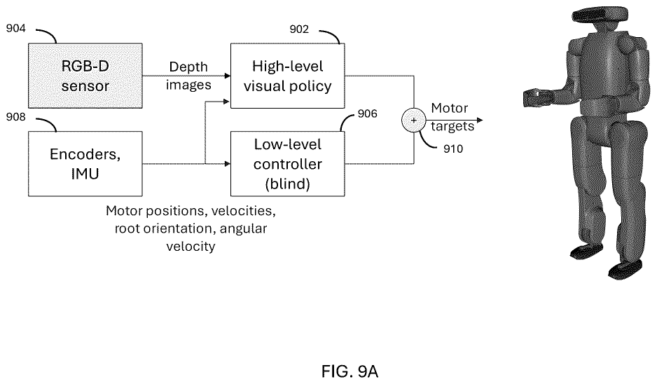

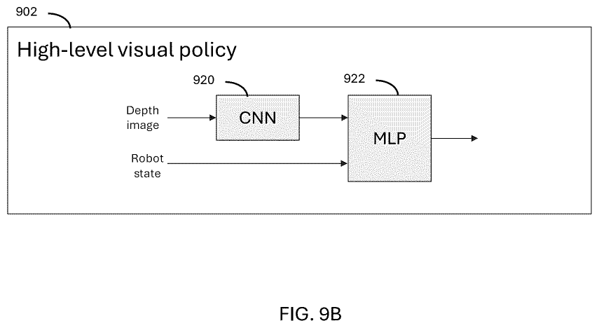

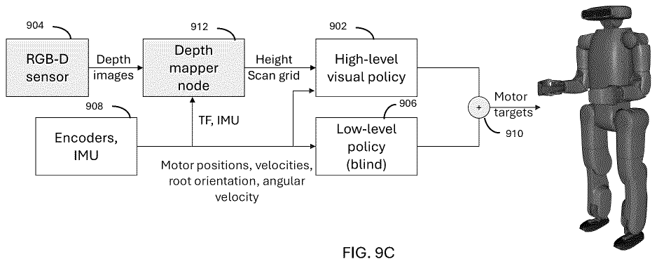

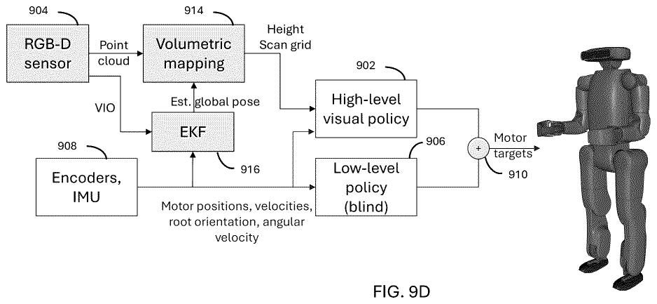

Example implementations of process 800 are shown in FIGS. 9A-9E. FIG. 9A illustrates an example implementation of process 800 configured for direct observation, in accordance with some embodiments described herein. FIG. 9A illustrates a task-specific controller 902 for implementing a high-level visual policy based on visual input 904 and motion input 908. A basic motion controller 906 is used to implement a low-level blind controller based on motion inputs 908. The outputs of the task-specific controller 902 and the basic motion controller 906 are combined using a fusion node 910.

In some embodiments, visual input 904 is produced by an RGB depth sensor. The RGB depth sensor may output depth images. The depth images include distance measurements from the RGB depth sensor to surfaces within the field of view of the robotic system. In some embodiments, the depth sensor may be monochromatic. In such embodiments, separate RGB sensors may be used in connection with object identification and depth sensors may be used for measuring distances to surfaces within the field of view. Task-specific controller 902 produces task-specific control signals that are combined with the basic motion controller 906 control signals to produce control signals for the robotic system.

In some embodiments, visual input 904 may be collected by the robotic system with the field of view directed at an interaction area. For example, in a stair climbing task-specific model, the robotic system may angle the vision subsystem of the robotic system to collect a field of view of the area in front of the robotic system. In this way, the visual input may directly capture the surfaces that the robot will interact with when climbing stairs. For other examples, the field of view may be directed at other interaction areas, as aspects of the technology described herein are not limited to stair climbing. Other non-limiting examples may include door opening, shelf stocking, and object manipulation.

Motion input 908 may be encoder values or inertial measurements produced by an IMU, as described herein. The motion input 908 represents the current position of the components of the robotic system. In some embodiments, the motion input 908 includes motor positions, velocities, root orientation, and/or angular velocities.

Basic motion controller 906 produces motion control signals that correspond with basic movements. Basic motion controller 906 may be implemented in any suitable way to produce predetermined movements of the robotic system in response to the current position of components of the robotic system.

In some embodiments, basic motion controller 906 may be a trained machine learning model that produces control signals. For example, recurrent neural networks, actor-critic algorithms, or policy gradient models may be trained to produce basic motion movements of the robotic system. In other examples, other trained machine learning models may be used as aspects of the technology described herein are not limited in this respect.

In some embodiments, basic motion controller 906 may be implemented using a sequence of predetermined vectors to control the movement of specific components of the robotic system. For example, predetermined vectors may control actuators in the legs of the robotic system to produce a walking motion.

In some embodiments, basic motion controller 906 may be implemented using a proportional-integral-derivative (PID) control to generate control signals based on a target pose (based on specific positions for components of the robotic system) and input encoder signals that correspond to the actual positions of components of the robotic system.

In some embodiments, basic motion controller 906 may be implemented using any combination of the models described above or other methods of generating control signals to produce basic movements of the robotic system.

Task-specific controller 902 produces motion control signals that are based in part of the visual input of the robotic system and are thereby responsive to the actual environment around the robotic system. In some embodiments, the task-specific controller 902 may be implemented using one or more trained machine learning models. An example implementation is shown in FIG. 9B, discussed below. Other examples of the task-specific controller 902 include models configured to process visual input to identify surfaces and/or objects around the robotic system from which a target position for the robotic system may be determined and then further configured to generate control signals based on the current position of components of the robotic system that will move the robot from a current position to the target position.

Fusion node 910 may be implemented in any suitable way to combine the outputs from the basic motion controller 906 and the task-specific controller 902 to produce control signals for the robotic system to navigate based on the visual input 904. In some embodiments, fusion node 910 may be implemented as a fusion model that is trained to combine outputs from the basic motion controller 906 and the task-specific controller 902 according to one or more weight parameters that have been generated by training the fusion model. In some embodiments, fusion node 910 may be implemented as a plurality of weighted parameters to generate a weighted average of the outputs of basic motion controller 906 and the task-specific controller 902.

FIG. 9B illustrates an example embodiment of a task-specific controller 902, in accordance with some embodiments described herein. Task-specific controller 902 may be implemented using one or more trained machine learning models. In some embodiments, task-specific controller 902 includes an image processing trained machine learning model 920 configured to determine surfaces and/or objects in the field of view of the robotic system and a motion signal generating trained machine learning model 922.

As an example of image processing trained machine learning model 920, a convolutional neural network may be configured to process depth images to determine surfaces and/or objects in the field of view of the robotic system. As an example of motion signal generating trained machine learning model 922, a multilayer perception model may be configured to produce control signals based on the output of model 920 and the position of the robotic system.

FIG. 9C illustrates a second example implementation of process 800 configured for direct observation, in accordance with some embodiments described herein. The example in FIG. 9C includes shared components with the example in FIG. 9A. The description of similar components, as those shown in FIG. 9A, may be applicable to this configuration, therefore a repeated description is omitted. Relative to the example shown in FIG. 9A, the example shown in FIG. 9C includes a depth mapper node 912. Depth mapper node 912 is configured to process depth images from visual input 904 to output a height scan grid for processing by the task-specific controller 902.

Depth mapper node 912 may be implemented in any suitable way to generate a heigh scan grid of the field of view based on depth images received from the visual input 104 and positions of the robotic system received from motion input 908. In some embodiments, depth mapper node 912 receives as inputs depth images, a pose of the robotic system and encoder input representing the rotation of a neck and/or pelvis joint of the robotic system. The rotation of the neck and/or pelvis provide the depth mapper node data about the direction of the field of view relative to an area in front of the robotic system. Accordingly, the depth mapper node may generate a heigh scan grid of an area larger than the field of view of the robotic system. In some embodiments, the depth mapper node is implemented using one or more trained machine learning models.

FIG. 9D illustrates an example implementation of process 800 configured for robot centric observation, in accordance with some embodiments described herein. In the robot centric observation, the robotic system generates a volumetric map of the area around the robotic system with the robotic system positioned at, or near, the center of the volumetric map. A volumetric mapping node 914 may be included for generating the volumetric map based on visual input 904 and a pose of the robotic system. Accordingly, the robotic system may use the robot centric volumetric map to navigate in directions that are not presently captured within the field of view while still generating control signals specific to the environment around the robotic system. The example in FIG. 9D includes shared components with the examples in FIGS. 9A and 9C. The description of similar components, as those shown in FIGS. 9A and 9C, may be applicable to this configuration, therefore a repeated description is omitted.

Volumetric mapping node 914 may be implemented using any suitable method. In some embodiments, the volumetric mapping node may be implemented using one or more trained machine learning models. In some embodiments, the volumetric mapping node 914 may use the methods described herein for generating a volumetric map of the environment around the robotic system.

An EKF node 916 may process motion inputs 908 and visual input 904 to generate a pose estimate of the robotic system. The output pose of the robotic system is provided to the volumetric mapping node 914 to aid in generating a volumetric map of the area around the robotic system that is provided to the task-specific controller 902 for generating control signals for the robotic system.

### VI. Working Examples

The following working examples are provided as nonlimiting illustrations of implementations of the systems and methods described herein. A person of skill in the art will understand and appreciate that additional variations, configurations, and combinations of the systems, methods, and examples discussed herein may be derived from the description included herein. Such variations, configurations, and combinations are intended as part of this disclosure.

Although organized into separate examples and descriptions below, each description may apply equally to the other listed examples unless explicitly state otherwise as each of the examples may be implemented together in combination with one another or may be combined with each other to produce other examples.

### VI.A. Example Method for Object Entry Event from Spatial Map

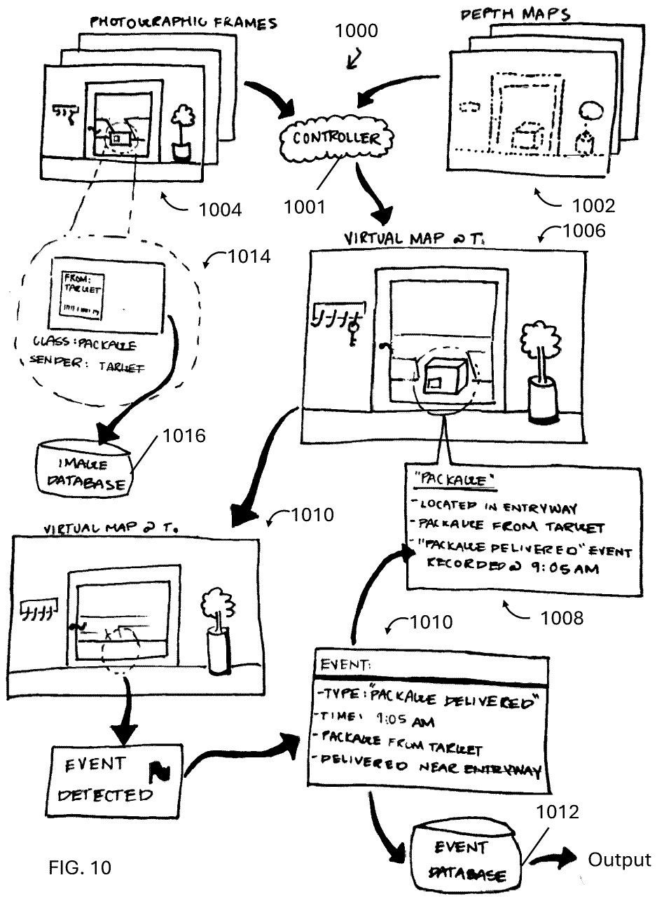

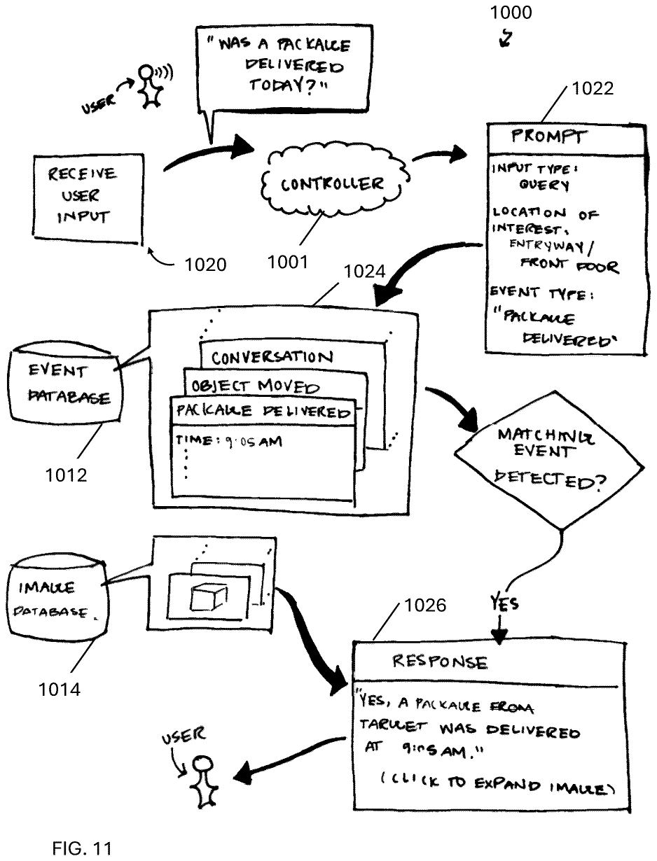

As shown in FIGS. 10 and 11, a method 1000 includes, during a scan cycle executed by controller 1001: accessing a depth map 1002 generated by a depth sensor (e.g., a structured light sensor) or other visual input arranged on a mobile robotic system occupying a space; accessing an image 1004 generated by an image sensor (e.g., a color camera) or other visual input arranged on the mobile robotic system; projecting a constellation of points, representing positions of a first set of features in the depth map, into a spatial map (e.g., a three-dimensional point cloud) of the space; and detecting a spatial difference between the first set of features, projected into the spatial map, and a second set of extant features in the spatial map.

The depth map may represent a spatial geometry of surfaces within a field of view of the depth sensor. The surfaces may be represented in any suitable format such that distances from the sensor to measurement points in the field of view are recorded. For example, the depth map may be a RDG-D image, PDM image, or other depth image formats.

The image representing visual characteristics may represent any visual characteristic of interest. For example, visual characteristics may include color, texture, patterns, and/or visual markers of surfaces within a field of view of the image sensor. In some embodiments, the visual characteristics may depend on the visual input hardware included with the robotic system.

The spatial map may be generated in any suitable format for tracking the spatial locations of objects and/or the environment around the robotic system. In some embodiments, three-dimensional point clouds may be used. In some embodiments, other three-dimensional formats may be used, as described herein. As an example, hierarchical maps may be generated where a foundation level of the map represents the environment needed for navigational purposes. An intermediate layer of the map may represent identified objects in the environment around the robotic system. A top layer of the map may represent spatial tags associated with semantic analysis that the robotic system associates with locations or objects in the hierarchical map.

The method 1000 further includes, in response to detecting the spatial difference: projecting a location of the spatial difference in the spatial map onto the image to refine a region-of-interest in the image 1006; and extracting a set of features from the region-of-interest in the image. The method 1000 further includes, in response to detecting presence of an object in the region-of-interest 1008 in the image, deriving a set of characteristics of the object based on the set of features.

The method 1000 further includes generating an object entry event including: a timestamp; a long-term-memory description of the set of characteristics to be stored in a long-term spatiotemporal database 1012; and an object location of the object in the spatial map. The method 1000 further includes storing the object entry event to a long-term-memory event log.

The method 1000 further includes generating a spatial memory record including: a short-term-memory description of the set of characteristics; and a pointer to a segment of the image containing the region-of-interest depicting the object. The method 1000 further includes: annotating the object location in the spatial map with the spatial memory record 1014; and storing the segment of the image containing the region-of-interest depicting the object in an image database 1016.

Short-term-memory entries, long-term-memory entries, and event log entries may be stored in spatiotemporal databases, as described herein. Databases may be structured in any suitable way depending on the implementation and the particular use case. In some embodiments, the spatiotemporal databases store spatial data with time signatures that correspond to the time the spatial data was collected. The spatiotemporal databases may further store additional information determined by or generated by the robotic system and associated with a particular location or object in the spatiotemporal database.

### VI. B Example Object Removal Event

As shown in FIGS. 10 and 11, one variation of the method 1000 includes, in response to detecting absence of an object in the region-of-interest in the image 1010, querying the spatial map for extant spatial memory records proximal the object location in the spatial map. This variation of the method 1000 further includes, in response to the spatial map returning an extant spatial memory record, extracting an extant short-term-memory description of characteristics of an extant object represented proximal to the object location in the spatial map.

This variation of the method 1000 further includes, generating an object removal event including: a timestamp; the extant short-term-memory description; and the object location of the extant object in the spatial map. This variation of the method 1000 further includes: storing the object removal event in the long-term-memory event log; and clearing the extant spatial memory record from the spatial map.

### VI.C. Example Object Entry Event from Color Image

As shown in FIGS. 10 and 11, one variation of the method 1000 includes: accessing a depth map generated by a depth sensor (e.g., a structured light sensor) or other visual input arranged on a mobile robotic system occupying a space, the depth map representing spatial geometry of surfaces within a field of view of the depth sensor; accessing an image generated by an image sensor (e.g., a color camera) or other visual input arranged on the mobile robotic system, the image representing visual characteristics (e.g., color, texture, patterns, visual markers) of surfaces within a field of view of the image sensor; and extracting a set of features from the image. This variation of the method 1000 further includes, based on the set of features: detecting a constellation of objects in the field of view of the image sensor; and, for each object in the constellation of objects, deriving a set of characteristics of the object.

This variation of the method 1000 further includes querying a spatial map (e.g., a three-dimensional point cloud) of the space for extant spatial memory records, representing objects previously detected in the space, analogous to the constellation of objects. This variation of the method 1000 further includes, in response to presence of a first object indicated in the constellation of objects and absence of the first object indicated in the extant spatial memory records, generating an object entry event including: a timestamp; a long-term-memory description of the set of characteristics; and a first object location of the first object in the spatial map. This variation of the method 1000 further includes storing the object entry event to a long-term-memory event log.

This variation of the method 1000 further includes generating a spatial memory record including: a short-term-memory description of the set of characteristics; and a pointer to a segment of the image containing a region-of-interest depicting the first object. This variation of the method 1000 further includes: projecting a position of the first object in the image to the first object location in the spatial map; annotating the first object location in the spatial map with the spatial memory record; and storing the segment of the image depicting the first object in an image database.

This variation of the method 1000 further includes, in response to absence of a second object indicated in the constellation of objects and presence of the second object indicated in the extant spatial memory records, extracting an extant short-term-memory description of characteristics of the second object represented in the spatial map. This variation of the method 1000 further includes generating an object removal event including: a timestamp; the extant short-term-memory description; and a second object location of the second object in the spatial map. This variation of the method 1000 further includes: storing the object removal event in the long-term-memory event log; and clearing an extant spatial memory record for the second object from the spatial map.

### VI.D. Example Queries and Accessing Short-Term Memory and Long-Term Memory

As shown in FIGS. 10 and 11, one variation of the method 1000 includes: receiving a query from a user; extracting a first set of language signals, representing object characteristics, from the query; extracting a second set of language signals from the query; interpreting an action specified by the query based on the second set of language signals; and querying the spatiotemporal database for spatial memory records containing extant short-term-memory descriptions of object characteristics congruent with the first set of language signals.

This variation of the method 1000 further includes, in response to the spatial memory returning an extant spatial memory record containing an extant short-term-memory description of object characteristics congruent with first set of language signals, executing the action based on the spatial memory record.

Furthermore, this variation of the method 1000 further includes, in response to failure of the spatial memory to return an extant spatial memory record containing an extant short-term-memory description of object characteristics congruent with the first set of language signals, querying the long-term-memory event log for events containing long-term-memory descriptions of object characteristics congruent with the first set of language signals.

### VI.E. Example Query Hit Confidence

As shown in FIGS. 10 and 11, one variation of the method 1000 includes: receiving a query from a user; extracting a first set of language signals, representing object characteristics, from the query; extracting a second set of language signals from the query; interpreting an action specified by the query based on the second set of language signals; and querying the spatiotemporal database for spatial memory records containing extant short-term-memory descriptions of object characteristics congruent with the first set of language signals.

This variation of the method 1000 further includes: receiving a first extant spatial memory record containing a first extant short-term-memory description of object characteristics; deriving a first confidence score for the first extant spatial memory record corresponding to the query based on a first correlation between the first set of language signals and the first extant short-term-memory description; and, in response to the first confidence score exceeding a threshold confidence score, executing the action based on the spatial memory record.

Furthermore, this variation of the method 1000 further includes: receiving a second extant spatial memory record containing a second extant short-term-memory description of object characteristics; and deriving a second confidence score for the second extant spatial memory record corresponding to the query based on a second correlation between the first set of language signals and the second extant short-term-memory description.

This variation of the method 1000 further includes, in response to the second confidence score falling below the threshold confidence score: querying a language model for a set of natural language descriptions of the first set of language signals; and querying the spatiotemporal database for spatial memory records containing extant short-term-memory descriptions of object characteristics congruent with the set of natural language descriptions.

### VI.F. Example Query Hit Confidence Based on Multiple Spatial Records

As shown in FIGS. 10 and 11, one variation of the method 1000 includes: receiving a query from a user; extracting a first set of language signals, representing object characteristics, from the query; extracting a second set of language signals from the query; interpreting an action specified by the query based on the second set of language signals; and querying the spatiotemporal database for spatial memory records containing extant short-term-memory descriptions of object characteristics congruent with the first set of language signals.

This variation of the method 1000 further includes, in response to the spatial memory returning a set of extant spatial memory records, each extant spatial memory record containing an extant short-term-memory description of object characteristics congruent with the first set of language signals, retrieving a set of images from an image database, each image depicting an object and corresponding to an extant spatial memory record in the set of extant spatial memory records.

This variation of the method 1000 further includes: generating a notification including the set of images and a prompt to select an image, from the set of images, corresponding to a target object specified by the user in the query; and serving the notification to the user (e.g., via a user interface).

### VI.G. Example Location Filter

As shown in FIGS. 10 and 11, one variation of the method 1000 includes: receiving a query 1020 (e.g., “Is there a package near the front door?”) from a user; extracting a first set of language signals using controller 1001, representing object characteristics, from the query; extracting a second set of language signals, representing a predefined region (e.g., the entryway) in the space, from the query; and interpreting an action specified by the query based on the second set of language signals. The extracted and interpreted language signals may comprise a semantic interpretation of a prompt 1022, generated in response to the received user query 1020.

This variation of the method 1000 further includes, in response to the second set of language signals representing the predefined region, querying the spatiotemporal database for spatial memory records containing extant short-term-memory descriptions of object characteristics congruent with the first set of language signals and located proximal the predefined region.

This variation of the method 1000 further includes, in response to the spatial memory returning an extant spatial memory record containing an extant short-term-memory description of object characteristics congruent with the first set of language signals located proximal the predefined region, executing the action based on the spatial memory record.

Furthermore, this variation of the method 1000 further includes, in response to failure of the spatial memory to return an extant spatial memory record containing an extant short-term-memory description of object characteristics congruent with the first set of language signals and located proximal the predefined region, querying the long-term-memory event log for events containing long-term-memory descriptions of object characteristics congruent with the first set of language signals located proximal the predefined region.

### VI.H. Example Time Filter

As shown in FIGS. 10 and 11, one variation of the method 1000 includes: receiving a query 1020 (e.g., “Was there a package entry event today?”) from a user; extracting a first set of language signals, representing object characteristics, from the query; extracting a second set of language signals, representing a target time period (e.g., the last eight hours), from the query; and interpreting an action specified by the query based on the second set of language signals.

This variation of the method 1000 further includes, in response to the second set of language signals representing a target time period within a predefined time period (e.g., the last 24 hours), querying the spatiotemporal database for spatial memory records: containing extant short-term-memory descriptions of object characteristics congruent with the first set of language signals; and recorded within the target time period.

This variation of the method 1000 further includes, in response to the spatial memory returning an extant spatial memory record containing an extant short-term-memory description of object characteristics congruent with first set of language signals and a timestamp congruent with the target time period, executing the action based on the spatial memory record.

Furthermore, this variation of the method 1000 further includes, in response to failure of the spatial memory to return an extant spatial memory record containing an extant short-term-memory description of object characteristics congruent with the first set of language signals and a timestamp congruent with the target time period, querying the long-term-memory event log for events containing long-term-memory descriptions of object characteristics congruent with the first set of language signals.

### VI.I. Example Applications

Generally, the method 1000 can be executed by a mobile robotic system in conjunction with a suite of sensors arranged on the mobile robotic system: to simultaneously record a depth map (e.g., via a depth sensor) and a photographic image (e.g., via an image sensor) of a space, each depth map and photographic image representing surfaces and objects within a particular region of the space; to compile these depth maps and photographic images into a spatial map representing features and objects detected within the space; to detect and record scene changes occurring within the space (e.g., changes to these objects) based on the spatial map; to transform characteristics (e.g., dimensions, colors, textures) of objects and/or event types (e.g., “object moved,” “object removed”) detected in these scene changes into natural language descriptors (or “tags”); to annotate points—representing these objects in the space—with these natural language descriptors; to associate these events with points representing corresponding objects and/or corresponding event locations in the spatial map; and to store these events in a long-term-memory event log in association with the corresponding point. In some embodiments, the method 1000 may be executed by the robotic system shown in FIGS. 1A, 1B, and 2, described herein.

Additionally, the mobile robotic system can execute Blocks of the method 1000: to detect and record audio and/or video events occurring within the space (e.g., human interactions); to transform characteristics (e.g., topics discussed during a conversation) of these events and/or event types (e.g., “human interaction,” “ambient condition change”) detected in these scene changes into natural language descriptors; and to annotate points—proximal a location of the event within the space—with natural language descriptors.

The mobile platform can then: receive a query from the user; retrieve data from the virtual map and/or the long-term-memory event log corresponding to this query; and serve a response to the user based on contextual data (e.g., object data, event data) contained in the virtual map and/or the long-term-memory event log. Alternatively, the mobile platform can: receive a command from the user; retrieve data from the virtual map and/or the long-term-memory event log corresponding to this command; and execute a sequence of actions (or interchangeably “tasks”) to complete the command based on contextual data (e.g., object data, event data) contained in the virtual map and/or the long-term-memory event log.

Accordingly, the mobile robotic system can: transform recognized object features (e.g., dimensions, colors, textures) derived from technical object recognition methods into natural language descriptions that are semantically aligned with human communication and comprehension; embed contextual data (e.g., object features, event metadata) directly within the virtual map and event database by annotating the spatial map with these natural language descriptions to create a low-data-storage yet semantically rich representation of the space; and leverage these natural language descriptors to accurately interpret and respond to user queries by linking user queries to annotated spatial and event records. By representing objects and object characteristics (e.g., dimensions, colors, textures) in natural language, the mobile robotic system can facilitate user-friendly querying by mapping user queries to annotated spatial records. Therefore, the mobile robotic system can generate a robust, searchable representation of the space that preserves semantic utility while significantly reducing the need to retain raw sensor data or high-resolution spatial imagery, thereby reducing storage requirements without compromising functionality in dynamic environments where spatial configurations and object states frequently change.

### VI.J. Example Dynamic Task Execution Based on Spatial Map Integration

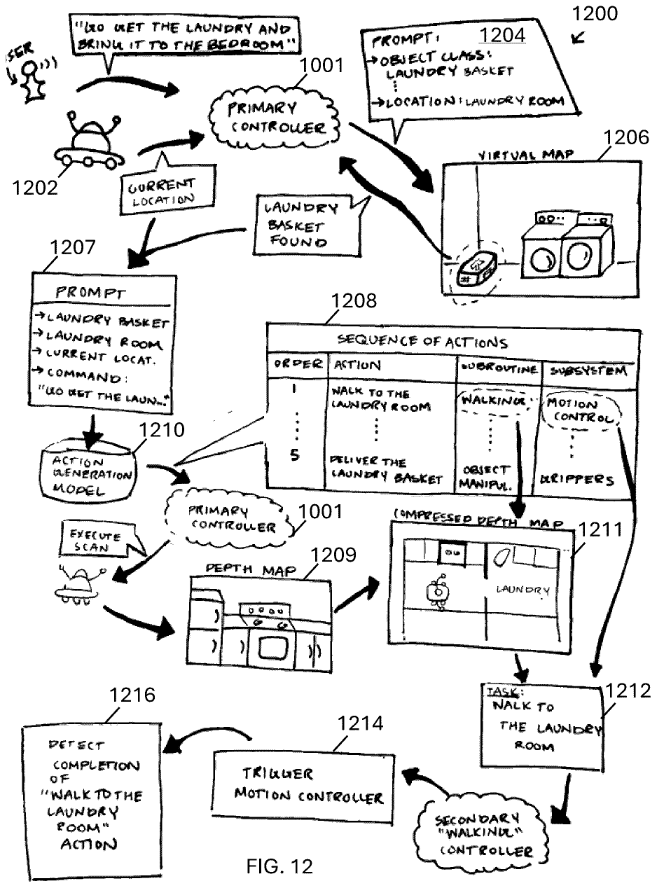

As shown in FIG. 12, one variation of the method 1200 includes, at a primary controller 1001 arranged within a mobile robotic system 1202: receiving a command (e.g., “Go get the laundry basket and bring it to the bedroom.”) from a user; extracting a first set of language signals 1204, representing a set of object characteristics and a target location in a space occupied by the mobile robotic system, from the query; extracting a second set of language signals from the query; interpreting an action specified by the query based on the second set of language signals; and querying the spatial memory for spatial records containing extant short-term-memory descriptions of object characteristics congruent with the first set of language signals. This variation of the method 1200 further includes identifying an extant spatial record 1206—stored in a spatial map of a space occupied by the mobile robotic system—containing an extant short-term-memory description of object characteristics congruent with the first set of language signals.

### VI.K. Example Natural Language-based Action Derivation

This variation of the method 1200 further includes, at the primary controller, in response to the spatial memory returning the extant spatial memory record: accessing a current location of the mobile robotic system represented in the spatial map; accessing a population of predefined subroutines (e.g., walking, ascending stairs, retrieving objects) executable by the mobile robotic system; generating a set of natural language descriptors of the command, the set of object characteristics, the target location, the current location of the mobile robotic system, and the population of predefined subroutines; generating a prompt 1207 including the set of natural language descriptors; transmitting the prompt to a task generation model 1210 (e.g., a large language model); and receiving an output 1208 from the task generation model responsive to the prompt, the output specifying a sequence of tasks (e.g., “walk to the laundry room,” “retrieve the laundry basket,” . . . “deliver the laundry basket”) for execution by the mobile robotic system.

This variation of the method 1200 further includes, at the primary controller, during execution of a first task (e.g., “walk to the laundry room”) in the sequence of tasks: accessing a set of state data of the mobile robotic system, the set of state data representing the first task in progress by the mobile robotic system; generating a second prompt specifying natural language descriptors of the command and the set of state data; transmitting the second prompt to the task generation model; and receiving a second output from the task generation model responsive to the second prompt, the second output 1212 specifying a target task for immediate execution by the mobile robotic system based on the command and the set of state data.

This variation of the method 1200 further includes, in response to the output specifying a target task congruent with the first task, withholding intervention to enable execution of the first task. This variation of the method 1200 further includes, in response to the output specifying a target task divergent from the first task: terminating execution of the first task; and initiating execution of the target task. This variation of the method 1200 further includes, in response to the output specifying a first target task congruent with the first task and a second target task divergent from the first task: maintaining execution of the first task; and initiating execution of the second target task.

### VI.L. Example Task-Specific Image Compression

This variation of the method 1200 further includes, at the primary controller 1001, for a first task (e.g., “walk to the laundry room”) in the sequence of tasks: identifying a first subroutine (e.g., walking), in the population of predefined subroutines, corresponding to the first task; identifying a subsystem (e.g., a motion control subsystem) integrated into the mobile robotic system and configured to execute elements of the first subroutine; triggering a depth sensor arranged on the mobile robotic system to generate a depth map 1209 of the space; and compressing the depth map according to a compression template, in a population of predefined compression templates, defined for the subsystem to generate a compressed depth map 1211. This variation of the method 1200 further includes, at the primary controller 1001, in response to detecting absence of an obstruction represented in the compressed depth map, transmitting the first task to a secondary controller 1214 (e.g., a walking controller) configured to trigger execution of the first task via the subsystem. This variation of the method 1200 further includes, detecting completion of the first subroutine 1216 based on a signal transmitted to the primary controller 1001 by a sensor integrated with the subsystem.

### VI.M. Example: Generating a Contextually-Aware Sequence of Tasks

In one application, the mobile robotic system can generate a sequence of tasks responsive to a user command (e.g., “Retrieve my jacket from the closet”). In particular, in this application, the mobile robotic system can: query the spatial map for relevant object data (e.g., the location, orientation, and classification of objects such as “jacket” or “closet”); query the long-term memory event log for relevant event data (e.g., prior interactions with the closet or updates about the location of the jacket); transform the command and contextual data into a sequence of tasks (e.g., “navigate to the closet,” “search for the jacket,” “retrieve the jacket,” “return to the user”) for execution by various subsystems integrated with the mobile robotic system, to complete the command; monitor feedback from a suite of sensors (e.g., depth sensors, tactile sensors, or cameras) integrated with the subsystems during execution of this sequence of tasks; and, based on this feedback, dynamically adapt the sequence of tasks, such as by recalibrating trajectory along a path, adjusting grip strength during object manipulation, or initiating a re-planning process if the task cannot be completed as initially intended.

Accordingly, the mobile robotic system can integrate contextual data (e.g., historic object and event data) and real-time sensor input (e.g., positioning, depth, and tactile feedback) to identify the spatial and contextual requirements of the task and derive a plan for task execution. Therefore, the mobile robotic system can combine stored memory, real-time perception, and task-specific reasoning to autonomously generate, execute, and adapt sequences of tasks to complete user commands in dynamic environments.

### VI.N. Example: Task Execution: Task-Specific Controllers

In one application, the mobile robotic system can implement a hierarchical control structure to execute the generated sequence of tasks. In particular, in this application, for a first task (e.g., “walk to the stairs”) in a sequence of tasks, the primary controller can: map the first task to an instruction for a particular subsystem integrated into the mobile robotic system, such as a motion control subsystem or a manipulation subsystem; trigger a depth sensor arranged on the mobile robotic system to generate a depth map representing the immediate environment; and compress the depth map according to a task-specific compression template defined for the subsystem. For example, for a manipulation controller, the compressed depth map can focus on object contours and grasp points to enhance the ability to interact with nearby objects. The primary controller can then analyze the compressed depth map to identify task-relevant spatial information, such as presence and position of a target object for manipulation or retrieval.

Accordingly, rather than analyzing detailed (i.e., uncompressed) depth maps, the mobile robotic system can focus on task-relevant spatial features tailored to the requirements of specific tasks, thereby reducing computational resources required to process the depth map. Therefore, the mobile robotic system can leverage compressed depth maps to reduce latency in task execution while preserving essential features necessary for accurate and efficient operation.

### VII.A Example Application: Package Detection

In one example application, during a first time period, a mobile robotic system: autonomously maneuvers to an entryway of a home; and executes a scan cycle to generate (or update) the spatial map and the events log to reflect objects, activities, and context within the entryway. In particular, the mobile robotic system can: detect presence of a package proximal the entryway represented in the spatial map; and identify a set of characteristics of the package, such as: a color (e.g., brown), a package type (e.g., rectangular box), and a sender or carrier identification from a shipping label arranged on the package.

The mobile robotic system then transforms these detected characteristics into natural language descriptors including: event type descriptors (e.g., “delivery received,” “object detected near entryway,” or “box detected,”); object type descriptors (e.g., “package,” “box,” “box,” or “delivery”); and object characteristics descriptors, such as color descriptors (e.g., “brown,” “light brown,” or “tan”), package type descriptors (e.g., “rectangular box,” “cardboard box,” or “small package”), and sender descriptors (e.g., “Amazon”).

The mobile robotic system then: stores an image of the package in an image database; records a “package entry” event record in the long-term-memory event log and populates this event record with the natural language descriptors of the package, a link to the image, and a timestamp corresponding to detection of the package; and annotates the points representing the package with a spatial record containing the natural language descriptors, a link to the “package entry” event record in the long-term-memory event log, a link to the image in the image database, and/or the timestamp.

Later, the mobile robotic system receives a query, from the user, such as “Was there a packaged delivered today?” and transforms the query into natural language descriptors, such as: possible natural language descriptors of a package (e.g., “brown box,” “white box with text or icons,” “white bubble envelope,” “yellow envelope”); likely natural language descriptors of a location related to the query (e.g., “packages are often left near exterior doors, either inside or outside”); and natural language descriptors of relevant time windows (e.g., “today,” “within the last 24 hours”). Because the query includes a time component indicating relevance of the query to the current day and therefore likely relevance to the short-term-memory spatial map, the mobile robotic system can first scan the short-term-memory spatial map for events containing natural language object descriptors analogous to these natural language query descriptors. If the spatial map returns a “package entry” spatial record containing such analogous object, location, and/or time descriptors, then the mobile robotic system can return confirmation of the query, such as based on data extracted from the “package entry” spatial record. For example, the mobile robotic system can return an audio response “Yes, a package was delivered today at 9:05 AM.”) to the user based on data contained in the matched spatial record.

Alternatively, if the spatial map fails to return a matched spatial record, the mobile robotic system can then scan the long-term-memory event log for events containing natural language object descriptors analogous to the natural language query descriptors. In response to identifying the “package entry” event record containing such analogous object, location, and/or time descriptors, the mobile robotic system can return confirmation of the query to the user.

### VII.B. Example Application: Sensors and Language Models

The method 1000 is described herein as being executed by a mobile robotic system that: includes depth sensors (e.g., RADAR sensors, LIDAR sensors, structured light sensors) and separate two-dimensional image sensors (e.g., color cameras); and executes Blocks of the method 1000 based on separate depth images and photographic images captured by these sensors. Additionally or alternatively, the mobile robotic system can: include integrated depth and image sensors (e.g., a stereoscopic camera) to output three-dimensional color images; and execute Blocks of the method 1000 based on these combined depth and color data output by these sensors.

Furthermore, the method 1000 is described herein as being executed by the mobile robotic system that stores a language model (e.g., a local instance of a large language model) in local memory and passes prompts to this local language model to derive characteristics of objects in scenes and to generate search terms for the spatial map and the events log. Additionally or alternatively, the mobile robotic system can execute Blocks of the method 1000: to generate prompts, package prompts with filtered data from the spatial map and/or the events log; to upload this package to a remote language model executed remotely (e.g., on a remote computer network or remote server); and to handle responses returned by the remote language model.

Furthermore, the method 1200 is described herein as executed by the mobile robotic system that stores a task generation model (e.g., a local instance of a task generation model) in local memory and passes prompts to this local task generation model to derive sequences of tasks for execution by the mobile robotic system. Additionally or alternatively, the mobile robotic system can execute Blocks of the method 1200: to generate prompts, package prompts with filtered data from the spatial map, the events log, and/or sensors integrated into the mobile robotic system; to upload this package to a remote task generation model executed remotely (e.g., on a remote computer network or remote server); and to handle responses returned by the remote task generation model

### VII.C. Example Application: Depth Maps and Spatial Map

Generally, the mobile robotic system can execute Blocks of the method 1000 while autonomously navigating through a space (e.g., a house, an apartment, an office, a property, a campus) to: capture depth maps of a scene currently occupied by the mobile robotic system via depth sensors (e.g., RADAR sensors, LIDAR sensors, structured light sensors) arranged on the mobile robotic system; and capture photographic (e.g., color) images of the scene via image sensors (e.g., RGB cameras) arranged on the mobile robotic system. The mobile robotic system can then update the spatial map of the space based on these depth maps and photographic images.

The mobile robotic system can further execute Blocks of the method 1000: to detect entry or repositing of objects within the scene based on these depth maps and/or photographic images; to populate the spatial map with short-term-memory spatial records containing natural language descriptions of objects newly-detected (or newly-detected in new positions) in the scene; to populate the spatial map with short-term-memory spatial records containing natural language descriptions of actions (e.g., inter-personal conversations, music playback) occurring in the scene; to update the spatial map to remove spatial records associated with objects newly-identified as removed from the scene or associated with activities newly-identified as ceased within the scene; and to append a long-term-memory events log with event records representing addition, removal, and repositioning of objects and changes in activities or context within the scene.

More specifically, the mobile robotic system can compile data extracted from depth maps and/or photographic images into a spatial map containing spatial records representing last known types, positions, characteristics, and context of objects visible to the mobile robotic system when the mobile robotic system occupied each scene within the space. In particular, by removing obsolete spatial records that no longer represent objects present in a scene, the mobile robotic system can maintain the spatial map as exclusively a last spatial representation of each scene occupied by the mobile robotic system, thereby controlling (i.e., limiting) a total data size of the spatial map. However, to preserve long-term-memory of scenes within the space, the mobile robotic system can also: generate an event record—containing lightweight timestamp, location, tags, and/or natural language description information—for each object entry, object removal, and object transfer event and context events (e.g., interpersonal conversation, music playback) detected in the space by the mobile robotic system; and store these event records in an events log.

Upon receipt of a prompt—related to objects, activities, or context of the space—from a user, the mobile robotic system can selectively query the spatial map and/or the events log for data supporting a response to the prompt and either return these data to the user or autonomously execute an action responsive to the prompt based on these data.

### VII.D. Example Application: Find an Object

In one example in which the mobile robotic system includes a humanoid domestic assistant deployed in a home, a user may ask the mobile robotic system, “Where did I leave my wallet?” Accordingly, the mobile robotic system can: interpret the query as a short-term-memory query requiring information about a last instance of the object (i.e., wallet) presence; query a language model for natural language descriptors of dimensions, colors, and/or textures common to wallets; and query the spatial map for a spatial record containing a “wallet” natural language descriptor and/or natural language descriptors of dimensions, colors, and/or textures of wallets returned by the language model. In response to the spatial map returning confirmation of this spatial record, the mobile robotic system can: query a language model for a natural language description of a location associated with this matched spatial record, such as based on objects represented in other spatial records adjacent the matched spatial record; and return a natural language output of the language model to the user (e.g., “on the northwest corner of the desk in the office, behind the stack of books”).

### VII.E. Example Application: Take an Action

In another example in which the mobile robotic system includes a humanoid domestic assistant deployed in a home, a user may instruct the mobile robotic system, “Put away the clothes in the laundry basket.” Accordingly, the mobile robotic system can interpret the command as both: a short-term-memory query requiring information about a last instance of the object (i.e., laundry basket) presence; and a long-term-memory query requiring information about laundry-related events (e.g., folding or sorting activities). The mobile robotic system can then: query the language model for natural language descriptors of dimensions, colors, and/or textures common to laundry baskets; and query the spatial map for a spatial record containing a “laundry basket” natural language descriptor and/or natural language descriptors of dimensions, colors, and/or textures of laundry baskets returned by the language model.

In response to the spatial map returning confirmation of this spatial record, the mobile robotic system can: query the language model for natural language descriptors of locations and/or organizational preferences common to laundry storage events; and query the long-term-memory event log for events containing a “laundry storage event” natural language descriptor and/or natural language descriptors of locations and/or organizational preferences common to laundry storage events returned by the language model.

In response to the long-term-memory event log returning information associated with similar events, the mobile robotic system can execute a sequence of actions to autonomously complete the task, such as: navigating to the location of the laundry basket identified in the spatial map; retrieving the laundry basket (e.g., via a set of manipulators); transporting the laundry basket to a location; and sorting clothing contained within the laundry basket into preferred storage locations (e.g., placing shirts in the master bedroom closet, storing towels in the bathroom cabinet). Upon completing the task, the mobile robotic system can: query the language model to generate a natural language confirmation of task completion, such as “The laundry has been put away in the closet,”; and return a natural language output of the language model to the user

### VII.F. Example Application: Spatial Map Updates

Generally, the mobile robotic system can selectively re-scan predefined regions of the space and update corresponding portions of the spatial map as the mobile robotic system maneuvers through these different (i.e., non-overlapping) predefined regions of the space. For example, the mobile robotic system can trigger a scan cycle in response to detecting a spatial trigger, such as traversing a predefined spatial threshold that separates a first predefined region from a second predefined region of the space.

In one implementation, the mobile robotic system can: at a first time, maneuver to a first predefined region (e.g., a kitchen) of the space; execute a first scan cycle to capture a first depth map representing spatial geometry of surfaces in the first predefined region, and a first image representing visual characteristics of surfaces in the first predefined region; and update the spatial map of the first predefined region based on the first depth map and the first image.

The mobile robotic system can then: at a second time succeeding the first time, maneuver to a second predefined region (e.g., a bedroom), different from the first predefined region; execute a second scan cycle to capture a second depth map representing spatial geometry of surfaces in the second predefined region, and a second image representing visual characteristics of surfaces in the second predefined region; and update the spatial map of the second predefined region based on the second depth map and the second image.

Then, the mobile robotic system can: at a third succeeding the second time, maneuver to the first predefined region (e.g., the kitchen); execute a third scan cycle to capture a third depth map representing spatial geometry of surfaces in the first predefined region, and a third image representing visual characteristics of surfaces in the first predefined region; and update the spatial map of the first predefined region based on the third depth map and the third image.

Furthermore, the mobile robotic system can implement methods and techniques described above to: detect entry or movement of objects within the first predefined region by comparing the first depth map and/or photographic image to the third depth map and/or photographic image; and update the spatial map to remove spatial records associated with objects newly-identified as removed from the first predefined region or associated with activities newly-identified as ceased within the scene.

The mobile robotic system can, therefore, maintain an updated spatial map reflecting temporal and spatial changes in the environment as the mobile robotic system maneuvers through the space. For example, the mobile robotic system can passively maneuver through predefined regions of the environment on a periodic schedule (e.g., hourly, daily, or based on environmental conditions), and execute scan cycles within these regions according to the schedule.

Alternatively, the mobile robotic system can maneuver to and execute a scan cycle within a particular region of the space responsive to input from the user. For example, in response to receiving an instruction from the user—such as an instruction to locate and retrieve an object within a target region (e.g., the kitchen) of the space—the mobile robotic system can: access a set of spatial coordinates of the target region; navigate to the target region according to the set of spatial coordinates; execute a scan cycle to capture a depth map and an image depicting surfaces in the target region of the space; implement methods and techniques described above to update the spatial map to reflect the target region according to the scan cycle; and selectively query the spatial map to identify and localize the object for retrieval, as discussed in detail below.

### VII.G. Example Application: Photographic Images

Generally, the mobile robotic system can detect, track, and characterize objects in two-dimensional photographic images (hereinafter referred to as “frames”)—recorded by an image sensor (e.g., a two-dimensional color camera) arranged on the mobile robotic system. The mobile robotic system can then fuse these images with the spatial map to augment the spatial map with detailed visual annotations to enhance object identification.

In one implementation, as the mobile robotic system maneuvers through a space, the mobile robotic system can execute a scan cycle to simultaneously capture: a depth map via the depth sensor; and an image via the image sensor. In particular, the mobile robotic system can execute the scan cycle to capture the image representing visual characteristics (e.g., color, texture, patterns, visual markers) of surfaces within the space and within a field of view of the image sensor during each scan cycle.

### VII.H. Example Application: Change Detection in Spatial Map

In one implementation, the mobile robotic system can: access a depth map representing spatial geometry of surfaces in the space; project a constellation of points, representing positions of a first set of features in the depth map, into the spatial map; and detect a spatial difference between the first set of features, projected into the spatial map, and a second set of extant features in the spatial map.

In particular, the mobile robotic system can: extract geometric and dimensional surface features (e.g., edges, corners) from the depth map; and identify a region of the spatial map corresponding to the field of view of the depth sensor based on a correlation between these geometric and dimensional surface features and the spatial surface features represented in the spatial map. The mobile robotic system can then project a constellation of points, in the depth map, into the spatial map.

### VII.I. Example Application: Object Detection and Characterization

Generally, the mobile robotic system can identify object characteristics (e.g., size, color, shape) and/or an object class (e.g., “household items,” “furniture,” “personal belongings”) of an object, and annotate a location—corresponding to the object—in the spatial map with the object characteristics and/or class.

In one implementation, in response to detecting a spatial difference in the spatial map, the mobile robotic system can: project a location of the spatial difference in the spatial map onto the image to refine a region-of-interest in the image; and extract a set of features (e.g., point density, spatial arrangement, surface properties, or color profiles) from the region-of-interest in the image. The mobile robotic system can then, in response to detecting presence of an object (e.g., a package) in the region-of-interest in the image, derive a set of characteristics (e.g., package size, color, shape) of the object based on the set of features. For example, the mobile robotic system can identify characteristics of the object, such as: the number of detected surfaces of the object; the orientation of the object; the size (e.g., dimensions, volume) of the object; the color(s) of the object; text, symbols, or visual patterns present on a surface of the object; and/or any other characteristics, feature, or attributes of the object.

In one implementation, upon detecting presence of an object in the image, the mobile robotic system can detect the orientation (e.g., pitch, roll, and yaw) of the object in addition to a position of the object relative to the mobile robotic system or a local virtual origin defined by the mobile robotic system. For example, upon detecting a presence of a desk in the space, the mobile robotic system can identify the orientation of the desk based on features of the desk, such as the planar surfaces of the desktop surface and the desk legs.

### VII.J. Example Application: Spatial Memory Record Based on Spatial Map

In one implementation, in response to the presence of a newly-detected object (or newly-detected in new positions) in the scene, the mobile robotic system can populate the spatial map with short-term-memory spatial records containing natural language descriptions of the object. In particular, in this implementation, in response to detecting presence of a spatial difference—between features projected into the spatial map and features extant in the map—and detecting presence of an object (e.g., a package) corresponding to the spatial difference, the mobile robotic system can: implement methods and techniques described above to identify the set of characteristics of the object; and generate a spatial memory record including a short-term-memory description of the set of characteristics. More specifically, the mobile robotic system can: query a language model for natural language descriptors of the object and/or the set of characteristics of the object; and generate the spatial memory record including the short-term-memory description containing natural language descriptions. The mobile robotic system can then: identify a location of the object in the spatial map; and annotate the location in the spatial map with the spatial memory record.

Accordingly, the mobile robotic system can: transform recognized object features (e.g., dimensions, colors, textures) derived from technical object recognition methods into natural language descriptions that are semantically aligned with human communication and comprehension; annotate the spatial map with these natural language descriptions to create a low-data-storage yet semantically rich representation of the space; and leverage these natural language descriptors to accurately interpret and respond to user queries by linking user input to annotated spatial records. By representing objects and object characteristics (e.g., dimensions, colors, textures) in natural language, the mobile robotic system can facilitate user-friendly querying by mapping user queries to annotated spatial records. Therefore, the mobile robotic system can generate a robust, searchable representation of the space that preserves semantic utility while significantly reducing the need to retain raw sensor data or high-resolution spatial imagery, thereby reducing storage requirements without compromising functionality.

In one example, the mobile robotic system: detects the presence of a wallet on a surface within the space; and identifies a set of object characteristics including a size (e.g., 10 cm×7 cm×1.5 cm), a shape (e.g., a flat, rectangular prism with rounded corners), a color (e.g., dark brown), and a surface pattern (e.g., a faint embossed logo on one side of the wallet). The mobile robotic system then calculates an orientation of the wallet as lying flat, with a top surface facing upward. The mobile robotic system then: queries the language model for natural language descriptors (e.g., billfold, cardholder, money clip, or coin purse) common to wallets and natural language descriptors of the set of object characteristics; identifies a location of the object in the spatial map; and annotates the location in the spatial map with the natural language descriptors common to wallets, and the natural language descriptors of the set of characteristics.

### VII.K. Example Application: Removing Spatial Records

In one implementation, in response to absence of a previously-detected object in the scene, the mobile robotic system can update the spatial map to remove spatial records associated with objects newly-identified as removed from the scene or associated with activities newly-identified as ceased within the scene. In particular, in this implementation, in response to detecting presence of a spatial difference-between features projected into the spatial map and features extant in the map- and detecting absence of an object corresponding to the spatial difference, the mobile robotic system can query the spatial map for extant spatial memory records proximal the object location in the spatial map. In response to the spatial map returning an extant spatial memory record, the mobile robotic system can: extract an extant short-term-memory description of characteristics of an extant object represented proximal the object location in the spatial map; and clear the extant spatial memory record from the spatial map. By removing obsolete spatial records that no longer represent objects present in a scene, the mobile robotic system can maintain the spatial map as exclusively a last spatial representation of each scene occupied by the mobile robotic system, thereby controlling (i.e., limiting) a total data size of the spatial map.

### VII.L. Example Application: Spatial Memory Record Based on Photographic Image

In this implementation, the mobile robotic platform can: implement methods and techniques described above to access a depth map and an image depicting surfaces in the space; extract a set of features from the image; and, based on the set of features, detect a constellation of objects in the field of view of the image sensor. Then, for each object in the constellation of objects, the mobile robotic platform can implement methods and techniques described above to derive a set of characteristics of the object. The mobile robotic platform can then query the spatial map for extant spatial memory records, representing objects previously detected in the space, analogous to the constellation of objects. In response to presence of a first object indicated in the constellation of objects and absence of the first object indicated in the extant spatial memory records, the mobile robotic platform can generate a spatial memory record including a short-term-memory description of the set of characteristics. The mobile robotic platform can then: project a position of the first object in the image to the first object location in the spatial map; and annotate the first object location in the spatial map with the spatial memory record.

Alternatively, in response to absence of a second object indicated in the constellation of objects and presence of the second object indicated in the extant spatial memory records, the mobile robotic platform can clear an extant spatial memory record for the second object from the spatial map.

### VII.M. Example Application: Object Classification

In one implementation, the mobile robotic system implements a classification model to assign one or more predefined classes—in a prepopulated set of (e.g., 300) unique object classes—to a particular object. In particular, in this implementation, the mobile robotic system can: identify the set of object characteristics, including shape descriptors (e.g., convexity, compactness), size, color profile, and surface patterns; and input the set of object characteristics into the classification model. The mobile robotic system can then receive an output responsive to this set of characteristics, the output including one or more predefined object classes (e.g., “box,” “chair,” “lamp”) of the object, each object class associated with a confidence score based on a correlation between the object and the predefined object class. For example, the mobile robotic system can first assign a primary class (e.g., “furniture”) and then refine the classification to a secondary class (e.g., “chair”) based on secondary features such as armrests, legs, and height.

For example, in the preceding example, the mobile robotic system: identifies the set of object characteristics of the wallet; inputs these characteristics into the classification model; and, based on the shape, size, and texture, the classification model assigns the object to the primary object class “personal belongings” and refines it to the secondary object class “wallet” with a confidence score of 92%. The mobile robotic system then: identifies a location of the object in the spatial map; and annotates the location in the spatial map with the primary object class (e.g., “personal belongings”), the secondary object class (e.g., “wallet”), and a timestamp corresponding to the time of detection of the wallet. Therefore, the mobile robotic system can extract object characteristics and assign object classifications to objects detected in the spatial map and annotate these objects in the spatial map to enable later querying of objects, such as by object class (e.g., retrieving all “personal belongings”) or by specific object characteristics (e.g., identifying a “dark brown wallet”).

### VII.N. Example Application: Image Linking

In one variation, the mobile robotic system can link an image of a detected object to a location of the detected object within the spatial map. In this variation, the mobile robotic system can implement methods and techniques described above: to access an image and detect an object (e.g., a package) in the image; and to identify a location of the object in the spatial map,

The mobile robotic system can then: generate a cropped image of the object by isolating the relevant region-of-interest in the image (e.g., excluding extraneous background elements); append the spatial memory record with a link to the cropped image; and store the cropped image in an image database containing a corpus of images captured in the space. Then, the mobile robotic system can serve the cropped image, depicting the object (e.g., a wallet), to the user responsive to a query (e.g., “Where is my wallet?”) with a prompt to verify that the detected object corresponds to an object of interest, as specified in the query.

Alternatively, rather than generating a cropped image, the mobile robotic system can: append the spatial memory record with a link to the image, the image containing a pointer to a segment of the image containing the region-of-interest depicting the object; and store the image (i.e., the original image) in the image database. Then, the mobile robotic system can serve the image—including a bounding box encompassing the object—to the user responsive to a query.

### VII.O. Example Application: Long-Term-Memory Event Log

Generally, the mobile robotic system can detect and record events occurring in the space (i.e., the environment surrounding the mobile robotic system), such as events (e.g., human interactions) proximal the mobile robotic system or scene changes detected between iterations of the spatial map. In particular, upon generating an initial spatial map of the space, the mobile robotic system can detect and record scene changes within the space (e.g., changes to object locations, introduction of objects, removal of objects) upon detecting these changes in a subsequent virtual representation of the space.

Additionally or alternatively, the mobile robotic system can detect and record events that occur proximal the mobile robotic system, such as: audio events (e.g., conversations, music playing, a doorbell ringing); and/or visual events (e.g., human interactions). The mobile robotic system can then store these detected events in a long-term-memory event log, indexed with metadata such as: an event type (e.g., scene change, audio event, visual event); a timestamp and/or duration of the event; spatial context, such as the object's location in the spatial map or proximity to the mobile robotic system; and/or associated sensor data, such as relevant depth maps, images, or audio recordings captured during the event.

### VII.P. Example Application: Scene Changes

In one implementation, the mobile robotic system can navigate through distinct regions of the space while executing scan cycles to capture depth and visual data. Upon returning to a previously-scanned region, the mobile robotic system can compare newly acquired data with data from the earlier scan cycle to detect scene changes, such as the introduction, removal, or relocation of objects. In particular, the mobile robotic system can implement methods and techniques described above: to execute a first scan cycle to capture a first depth map and a first image representing surfaces in the space during a first time period; to generate a spatial map of the space based on the first depth map and the first image; to detect, characterize, and annotate objects within the spatial map during the first time period; and to execute a second scan cycle to capture a second depth map and a second image representing surfaces in the space during a second time period succeeding the first time period.

The mobile robotic system can then directly compare the second (i.e., the current) depth map to the first depth map (i.e., the last representation) of the scene recorded in the spatial map to detect a new change in the scene, such as addition, removal, or repositioning of an object in the scene. Then, responsive to detecting a change in a particular location within the scene, the mobile robotic system can: isolate a corresponding region-of-interest in a concurrent photographic image captured by the mobile robotic system; implement computer vision techniques and/or a large language model to detect an object in this region-of-interest and to derive natural language description or tags representing characteristics of the object; store this region-of-interest of the photographic image in an image database; generate a spatial record identifying the object, including natural language description of the object, and linked to the region-of-interest of the photographic image; and annotate the particular location in the spatial map with this spatial record.

More specifically, the mobile robotic system can detect scene changes by: detecting presence of an object in a spatial map, the object absent in a previously-generated spatial map (e.g., indicating the introduction of an object to the space); detecting variations in the spatial configuration of an extant object (e.g., indicating an adjustment to a location and/or orientation of an object); and detecting absence of an extant object in the current spatial map, the extant object present in a previously-generated spatial map (e.g., indicating the removal of an object from the space). In response to detecting a scene change, the mobile robotic system can store this scene change as an event in the long-term-memory event log containing a corpus of historically-recorded events. In particular, the mobile robotic system can derive a location of the constellation of points—representing the object—in the spatial map, such as based on the spatial coordinates of the object relative to the global coordinate system defined by the spatial map.

In one implementation, in response to detecting presence of a spatial difference—between features projected into the spatial map and features extant in the map—and detecting presence of an object (e.g., a package) corresponding to the spatial difference, the mobile robotic system can: implement methods and techniques described above to identify the set of characteristics of the object; and generate an object event entry including a long-term-memory description of the set of characteristics, a timestamp, and a location of the object in the spatial map. More specifically, the mobile robotic system can: query the language model for natural language descriptors of event types (e.g., “delivery received”) associated with the scene change; query the language model for natural language descriptors of the object and/or the set of characteristics of the object; and generate the object entry event including the long-term-memory description containing natural language descriptions. The mobile robotic system can then store the object entry event in the long-term-memory event log.

In one example, the mobile robotic system: detects a package, in an image, proximal an entryway (i.e., a first predefined region) of a home (i.e., a space); identifies a set of characteristics of the package, such as: a color (e.g., brown), a package type (e.g., rectangular box), and a sender identification (e.g., “Amazon Fulfillment Services”) from a shipping label arranged on the package; queries the language model for natural language descriptors of event types associated with the scene change; and queries the language model for natural language descriptors of the object and/or the set of object characteristics. For example, responsive to the query, the mobile robotic system can receive: natural language descriptors of event types, such as “delivery received,” “object detected near entryway,” or “box detected,”; and natural language descriptors of the object, such as “package,” “box,” “box,” or “delivery.” Additionally, responsive to the query, the mobile robotic system can receive natural language descriptors of the set of object characteristics including: color descriptors, such as “brown,” “light brown,” or “tan”; package type descriptors, such as “rectangular box,” “cardboard box,” or “small package”; and sender descriptors, such as “Amazon.” The mobile robotic system then: generates an object entry event including the long-term-memory description containing these natural language descriptions, and a timestamp corresponding to detection of the package; and stores the object entry event in the long-term-memory event log. Therefore, the mobile robotic system can autonomously maintain: a dynamic and up-to-date virtual representation of the space by detecting and recording scene changes over time; and a historical record of changes for future querying and analysis.

### VII.Q. Example Application: Removing Spatial Records

In one implementation, in response to the absence of previously-detected objects in the scene, the mobile robotic system can append the long-term-memory events log with event records representing removal of objects. In particular, in this implementation, in response to detecting the presence a spatial difference-between features projected into the spatial map and features extant in the map- and detecting absence of an object corresponding to the spatial difference, the mobile robotic system can query the spatial map for extant spatial memory records proximal the object location in the spatial map. In response to the spatial map returning an extant spatial memory record, the mobile robotic system can: extract an extant short-term-memory description of characteristics of an extant object represented proximal the object location in the spatial map; generate an object removal event including a timestamp, the extant short-term-memory description, and the location of the extant object in the spatial map; and store the object removal event in the long-term-memory event log.

Accordingly, the mobile robotic system can: remove obsolete spatial records that no longer represent objects present in a scene in order to control (i.e., limit) a total data size of the spatial map; generate an event record-containing lightweight timestamp, location, tags, and/or natural language description information—for each object entry, object removal, and object transfer event and context events (e.g., interpersonal conversation, music playback) detected in the space by the mobile robotic system; and store these event records in an events log to preserve long-term-memory of scenes within the space. The mobile robotic system can therefore record and store these events to enable later querying and analysis (e.g., by a particular user) of information related to the space. For example a user may query the mobile robotic system to retrieve information such as, “What objects were moved in the living room yesterday?” or “What time was the door locked last night?”

### VII.R. Example Application: Audio Events

In one implementation, the mobile robotic system can detect and record audio events that occur proximal the robot; and populate the spatial map with short-term-memory spatial records containing natural language descriptions of these audio events (e.g., inter-personal conversations, music playback) occurring in the scene. In particular, in this implementation, the mobile robotic system can implement methods and techniques described above: to generate a spatial map of a space; and to detect, characterize, and annotate objects within the spatial map. Then, in response to detecting an audio signal (e.g., via a microphone integrated into the mobile robotic system) proximal the mobile robotic system, the mobile robotic system can: initiate an audio recording of the audio event; derive a set of characteristics of the audio event (e.g., duration, and detected keywords in speech); and implement an event classification model to derive one or more predefined event types—in a prepopulated set of (e.g., 100) unique event types—of the audio event.

In particular, in this implementation, the mobile robotic system can: transcribe the audio recording into a textual description; extract a set of language signals from the textual description; and query the language model for natural language descriptors of the set of language signals and/or event types (e.g., “conversation”) of the audio event. Furthermore, the mobile robotic system can derive a location (i.e., an approximate or average location) of the audio event within the space (e.g., based on sensor data detected by an array of microphones). The mobile robotic system can then: inject a point into the spatial map at the location; store the audio recording in a recording database containing a corpus of previously-captured audio recordings; and annotate the point with a short-term-memory record containing natural language descriptors, the event type, a link to the audio recording in the recording database, and a timestamp or a duration of the audio recording. The mobile robotic system can then: generate an audio detection event including the long-term-memory description containing natural language descriptions, a link to the audio recording in the recording database, and a timestamp or a time period of the audio recording; and store the object entry event in the long-term-memory event log.

Alternatively, the mobile robotic system can discard the audio recording, such as in response to the audio event: falling below a threshold duration (e.g., a conversation lasting fewer than five seconds); characteristic of a predefined set of event types (e.g., a door closing or ambient noise below an amplitude threshold); or containing an audio recording identified as redundant or previously recorded within a specific time image.

In one example, the mobile robotic system: initiates an audio recording in response to detecting an audio signal corresponding to a conversation between a first user and a second user; receives natural language descriptors of the set of language signals (e.g., “discussion of weekend plans”); receives natural language descriptors of event types (e.g., “conversation,” “human interaction”) of the audio event; derives a first location of the first user; and derives a second location of the second user. In this example, the mobile robotic system then disseminates the audio recording into: a first segment corresponding to segments of the audio recorded associated with speech of the first user; and a second segment corresponding to segments of the audio recorded associated with speech of the second user. The mobile robotic system then: stores the first and second segments of the audio recording in the recording database; injects a first point into the spatial map, represented by a first voxel corresponding to the first location of the first user; injects a second point into the spatial map, represented by a second voxel corresponding to the second location of the second user; annotates the first voxel with the short-term-memory record containing natural language descriptors, a first link to the first segment of the audio recording, and a time period of the audio recording; and annotates the second voxel with the short-term-memory record containing natural language descriptors, a second link to the second segment of the audio recording, and the time period of the audio recording.

In another example, in response to detecting movement of the first user and/or the second user within the space (i.e., the conversation does not correspond to a single location within the spatial map), the mobile robotic system can: track the movement of each user during the conversation; inject multiple points into the spatial map, represented by a series of voxels corresponding to the users' changing locations over time; and implement methods and techniques described above to annotate each of these voxels. Alternatively, the mobile robotic system can annotate a broader region of the spatial map that encompasses the users' movement during the conversation, such as a broader region representing the spatial extent of the event.

Accordingly, the mobile robotic system can effectively integrate audio data into the spatial map by associating recorded events with spatial and temporal context; and maintain a record of historical audio events linked to the spatial map. Therefore, the mobile robotic system can facilitate enhanced querying, such as identifying when and where specific sounds or conversations occurred or monitoring significant audio events within a space.

### VII.S. Example Application: Video Events

In one variation, the mobile robotic system can detect and record video events (e.g., human interactions, object movements) that occur proximal the robot. In particular, in this implementation, the mobile robotic system can implement methods and techniques described above: to initiate a video recording of the video event; to query the language model for natural language descriptors of a set of visual signals (e.g., human movements or gestures), and/or event types (e.g., “conversation”) of the video event; to derive a location (i.e., an approximate or average location) of the video event within the space; to store the video recording in the recording database; and to annotate a point in the spatial map at the location with the natural language descriptors, a link to the video recording in the recording database, and a timestamp or a duration of the video recording. Furthermore, the mobile robotic system can implement methods and techniques described above to store the video event in the long-term-memory event log.

In one variation, the mobile robotic system can implement methods and techniques described above to detect and record combined audio and visual events. In particular, in this variation, the mobile robotic system can implement methods and techniques described above: to initiate a video recording and an audio recording of the event; to query the language model for natural language descriptors of a set of language signals, a set of visual signals, and/or event types (e.g., “human interaction”) of the video event; to derive a location (i.e., an approximate or average location) of the event within the space; to store the video recording and the audio recording in the recording database; and to annotate a point in the spatial map at the location with the natural language descriptors, a link to the video recording and the audio recording in the recording database, and a timestamp or a duration of the event. Furthermore, the mobile robotic system can implement methods and techniques described above to store the event in the long-term-memory event log.

### VII.T. Example Application: User Query and User Command Ingest

Generally, the mobile platform can: receive commands (e.g., “Find my wallet.”), or queries (e.g., “Is there a package currently at the door?”) from a user; and transform these commands or queries into prompts to query the virtual map and/or the long-term-memory event log for data relevant to the commands or queries.

In one implementation, the mobile platform can: receive a command (e.g., an audio command, a textual command) from a user via a primary controller integrated into the mobile platform; transform the command into a prompt; and, based on the prompt, selectively query the virtual map and/or the long-term-memory event log to retrieve data relevant to the command. The mobile platform can then execute a sequence of actions to complete this command based on contextually relevant data extracted from the virtual map and/or the long-term-memory event log, as described in detail below.

In this implementation, the mobile platform can: receive the command (e.g., “Go get the laundry and bring it to the bedroom.”) from the user; extract a first set of language signals, representing object characteristics, from the query; extract a second set of language signals from the query, representing actions specified in the query; query the language model for natural language descriptors of the first and second sets of language signals; and receive a second prompt from the language model including these natural language descriptors.

The mobile platform can then: interpret an action specified by the query based on the second set of language signals; and query the spatial memory for spatial memory records containing extant short-term-memory descriptions of object characteristics congruent with the natural language descriptors. In response to the spatial memory returning an extant spatial memory record containing an extant short-term-memory description of object characteristics congruent with the first set of language signals, the mobile platform can execute the action based on the spatial memory record. Alternatively, in response to failure of the spatial memory to return an extant spatial memory record containing an extant short-term-memory description of object characteristics congruent with the natural language descriptors, the mobile platform can query the long-term-memory event log for events containing long-term-memory descriptions of object characteristics congruent with the first set of language signals.

In one example, the mobile platform can: receive a command from the user, such as “Go get the laundry and bring it to the bedroom”; and implement methods and techniques described above to query the language model for natural language descriptors. In this example, the mobile platform can then receive a prompt from the language model specifying: a set of object classes (e.g., “laundry basket,” “laundry bag,” “folded clothing,” or “unfolded clothing”); and a set of predefined locations in the virtual map (e.g., “laundry room,” “proximal a dryer,” or “proximal an ironing board”).

In another example, the mobile platform can: receive a query from the user, such as “What rooms have the lights on?”; implement methods and techniques described above to query the language model for natural language descriptors; and receive a second prompt from the language model specifying a set of predefined event types (e.g., “light turned on,” “light turned off”). The mobile platform can then selectively query the virtual map and/or the long-term-memory event log based on the second prompt.

### VII.U. Example Application: Virtual Map Queries Based on User Commands and Queries

In one implementation, upon transforming a user query (or command) into a prompt, the mobile platform can selectively query the virtual map to retrieve object data relevant to the user query (or the user command). For example, the mobile platform can implement methods and techniques described above: to receive a command (e.g., “Bring me my cell phone from the kitchen.”) from the user; and to transform the command into a prompt, such as a prompt specifying natural language descriptors, such as an object class (e.g., “phone”) of a target object (e.g., the user's cell phone) specified in the command, and a predefined location (e.g., the “kitchen”) in the virtual map.

The mobile platform can then, based on the prompt, query the virtual map: to detect objects, associated with the object class and represented in the virtual map; and to extract object data from the virtual map corresponding to these objects. In particular, in response to identifying a target object (e.g., a phone)—represented in the virtual map—associated with the object class and located within the predefined location, the mobile platform can extract a set of object data associated with the object from the virtual map. For example, the mobile platform can extract a set of object data including a location (e.g., a location of a constellation of points representing the wallet in the virtual map) of the target object. The mobile platform can then, based on the set of object data, generate a sequence of actions (e.g., “navigate to the kitchen,” “retrieve the phone”) to execute to complete the command, as discussed in detail below.

Alternatively, in response to detecting absence of a target object—in the virtual map, the mobile platform can implement methods and techniques described below: to query the long-term-memory event log, such as based on an event type (e.g., “wallet detected”) associated with the command; and to serve a response to the user that incorporates contextually-relevant event data extracted from the long-term-memory event log. For example, the mobile platform can generate a response indicating failure to detect the target object and including a set of event data associated with a relevant event (e.g., “I did not find your wallet. It was last seen on the kitchen counter at 8:03 AM).

### VII.V. Example Application: Event Database Queries Based on User Commands and Queries

In one implementation, and as illustrated in FIG. 11, upon transforming a user query 1020 (or a user command) into a prompt 1022, the mobile platform can selectively query the long-term-memory event log in the event database 1012 to retrieve event data relevant to the user query 1024 (or the user command). For example, the mobile platform can implement methods and techniques described above: to receive a query (e.g., “Was there a package entry event today?”) from the user; and to transform the query into a prompt specifying natural language descriptors, such as an event type (e.g., “packaged delivered”), and a target time period (e.g., the last eight hours).

The mobile platform can then, based on the prompt, query the long-term-memory event log: to identify events, associated with the event type and stored in the long-term-memory event log within the target time period; and to extract event data from the long-term-memory event log corresponding to these events. In particular, in response to identifying a target event (e.g., a “package entry event” occurring one hour prior to receipt of the query) that represents a match associated with the event type and occurring within the target time period, the mobile platform can extract a set of event data associated with the matched event from the long-term-memory event log.

For example, the mobile platform can extract a set of event data including: a location (e.g., a location of a constellation of points representing a package in the virtual map) associated with the event; a set of object characteristics (e.g., a sender of a package) of an object (e.g., a package) associated with the event; and/or a timestamp of the event. The mobile platform can then: generate a response to the query based on the set of event data 1026 (e.g., “A package from Target was delivered near the front door at 9:02 AM today.”); and serve the response to the user. In this example, the mobile platform can further: retrieve a frame, in the image database 1014, depicting the target object (e.g., the package proximal the front door); and serve the response, including the frame, to the user.

Alternatively, in response to detecting absence of a target event—associated with the event type and occurring within the target time period—in the long-term-memory event log, the mobile platform can implement methods and techniques described below: to navigate to a location, within the space, corresponding to the predefined location (e.g., the “front door”) in the virtual map; and to execute a scan cycle to update the region of the virtual map representing the predefined location. The mobile platform can then implement methods and techniques described above to serve a response to the user based on detecting presence or absence of an object, in the virtual map, representing the target object proximal the predefined location (e.g., a package proximal the front door). Therefore, the mobile platform can leverage the natural language descriptors stored in the virtual map and the long-term-memory event log to facilitate efficient querying of spatial and temporal information, execute navigational tasks, and deliver tailored responses to the user that incorporate this spatial and temporal context.

### VII.W. Example Application: Target Object Classes and Target Event Types

In one variation, the mobile robotic system can: analyze user inputs to derive a set of target object classes (e.g., “phone,” “wallet,” or “jewelry”) and/or a set of target event types (e.g., “conversation,” or “object moved”); and prioritize identifying these objects and/or events in the spatial map and storing corresponding events in the long-term-memory event log.

For example, the mobile robotic system can: receive frequent queries from a user asking, “Where is my phone?”; and characterize a “phone” object class as a high-priority object class based on these queries. The mobile robotic system can then: prioritize detecting and tracking the phone in successive iterations of the spatial map; store additional metadata (e.g., timestamp of last detection), in association with the phone, in the spatial map; and prioritize recording relevant events (e.g., “phone moved”) in the long-term-memory event log for retrieval responsive to future queries.

### VII.X. Example Application: Filtering the Spatial Map and Long-Term-Memory Event Log

In one variation, the mobile robotic system can selectively filter data from the spatial map and/or the long-term-memory event log, such as by removing and/or downgrading annotations for certain objects or events. In one example, the mobile robotic system can filter data corresponding to identified objects in the spatial map based on the object class (e.g., “pens,” or “kitchen utensils”), such as object classes associated with a low querying frequency. In another example, the mobile robotic system can downgrade annotations corresponding to identified objects in the spatial map, such as by removing links to images in the image database and/or removing links to video recordings in the recording database following expiration of a threshold time period (e.g., deleting a video recording and the corresponding link one year after a particular event is recorded).

### VIII.A. Example Application: Transforming Contextual Data into Actionable Sequences

Generally, responsive to a command (or a query), the mobile robotic system can: access object data and/or event data associated with the command; detect the current state of the mobile robotic system, such as a location of the mobile robotic system within the space (i.e., at a time of the command); and transform the current state data, object data, and/or event data into a sequence of tasks for execution by the mobile robotic system to complete a task specified in the command by the user.

In one implementation, the mobile robotic system can detect a set of state data of the mobile robotic system, such as: a location of the mobile robotic system-represented in the spatial map-within the space; and/or an orientation of the mobile robotic system within the space. For example, the mobile robotic system can detect the set of state data by interpreting signals detected by sensors integrated into the mobile robotic system, such as: positioning sensors (e.g., GPS, indoor localization systems); inertial sensors (e.g., gyroscopes, accelerometers); and/or depth sensors (e.g., LIDAR sensors).

Furthermore, the mobile robotic system can access a population of predefined subroutines (e.g., walking, ascending stairs, retrieving objects) executable by the mobile robotic system. The mobile robotic system can then: generate a prompt specifying natural language descriptors of the command (or the query), the set of state data, object characteristics, event characteristics, and/or the population of predefined subroutines; transmit the prompt to a task generation model; and receive an output from the task generation model responsive to the prompt, the output specifying a sequence of tasks for execution by the mobile robotic system.

In one example, the mobile robotic system can implement methods and techniques described above: to receive a command (e.g., “Go get the laundry and bring it to the bedroom.”) from the user; to query the spatial memory for spatial records containing extant short-term-memory descriptions of object characteristics congruent with the natural language descriptors (e.g., of object characteristics) derived from the query; and to receive an extant spatial record containing an extant short-term-memory description of object characteristics congruent with the natural language descriptors.

Additionally or alternatively, in this example, the mobile robotic system can implement methods and techniques described above: to query the long-term memory event log for events (e.g., “laundry detected”) containing long-term-memory descriptions of object characteristics congruent with the natural language descriptors; to identify an event (e.g., “unfolded clothing detected”) associated with the query; and to extract an extant long-term-memory description of characteristics of the event from the long-term memory event log, such as a predefined location (e.g., the “couch”) associated with the event.

The mobile robotic system then: accesses the current location (e.g., the “kitchen”) of the mobile robotic system represented in the spatial map; generates and transmits a prompt—specifying the current location, the natural language descriptors, and the target location—to the task generation model; and receives a sequence of tasks from the task generation model responsive to the prompt. For example, the mobile robotic system can receive a sequence of tasks specifying: “walk from the kitchen to the laundry room;” “retrieve the laundry basket;” “walk from the laundry room to the couch;” “retrieve the unfolded clothing;” and “walk to the bedroom.”

Accordingly, the mobile robotic system can: retrieve object data and/or event data relevant to a query or command; and generate instructions derived from this contextually relevant information to execute tasks specified by the user. Therefore, the mobile robotic system can dynamically process user commands by integrating state data, object data, and event data to generate and execute contextually-informed tasks.

### VIII.B. Example Application: Dissemination of Tasks to Secondary Controllers

Generally, upon receipt of a sequence of tasks responsive to a query (or a command), the primary controller can disseminate actionable instructions to secondary controllers integrated into the mobile robotic system; and selectively trigger the secondary controllers to execute these actionable instructions. In particular, the mobile robotic system can include a set of secondary controllers, wherein each secondary controller is configured to perform specialized tasks within specific domains, such as locomotion (e.g., navigating stairs, traversing flat surfaces) or manipulation (e.g., grasping, picking up, or placing objects). The primary controller can then selectively trigger the secondary controllers during execution of a particular sequence of tasks to transition the mobile robotic system between operational domains and complete the sequence of tasks.

### VIII.C. Example Application: Task-Specific Image Compression

In one implementation, the mobile robotic system can: identify an upcoming task (e.g., “walk to the laundry room”), in the sequence of tasks, for execution by the mobile robotic system; identify a subroutine (e.g., walking), in the population of predefined subroutines (e.g., walking, ascending stairs, retrieving items), corresponding to the task; and identify a secondary controller (e.g., a walking controller) configured to trigger execution of the first subroutine. The mobile robotic system can then: trigger the depth sensor to generate a depth map of the space; and compress the depth map according to a compression template, in a population of predefined compression templates, defined for the first subroutine to generate a compressed depth map.

In particular, the mobile robotic system can process a depth map for a particular secondary controller by uniquely compressing the depth map based on the task executed by the secondary controller. More specifically, each compression template can vary to store different levels of detail, such as coarser representations for general navigation and finer representations for precise manipulation tasks. For example, for a first secondary controller (e.g., a walking controller) configured to trigger execution of locomotion tasks, the mobile robotic system can compress depth maps to emphasize shape and geometry relevant to walking, such as terrain contours and obstacles. Alternatively, for a second secondary controller (e.g., a manipulation controller) configured to trigger execution of manipulation tasks, the mobile robotic system can compress depth maps to focus on object contours and grasp points to enhance the ability to interact with nearby objects.

In one example, the mobile robotic system can: identify a first task (i.e., an upcoming task), in the sequence of tasks, such as “walk to the kitchen”; and trigger the depth sensor to generate a first depth map (e.g., a three-dimensional point cloud) of the space. The mobile robotic system can then compress the first depth map according to a first compression template defined for the “walking” subroutine and specifying: exclusion of points from the first depth map corresponding to objects or surfaces located outside the forward-facing field of view of the depth sensor (e.g., defined by the negative z-axis relative to the platform's orientation in the coordinate frame); exclusion of points from the first depth map corresponding to objects or surfaces located outside of a predefined lateral boundary (e.g., ±5 feet along the x-axis in the platform's local coordinate system); and transformation of the first depth map (e.g., a three-dimensional point cloud) into a two-dimensional top-down projection by flattening points along the vertical y-axis and aggregating spatial features (e.g., average height, density) of these points into a plan view.

Then, upon completion of the first task, the mobile robotic system can: identify a second task (i.e., an upcoming task), in the sequence of tasks, such as “ascend the stairs”; and trigger the depth sensor to generate a second depth map of the space. The mobile robotic system can then compress the second depth map according to a second compression template defined for the “stairs” subroutine and specifying: exclusion of points from the depth map corresponding to objects or surfaces located outside the forward-facing field of view of the depth sensor; retention of points within a narrow lateral boundary (e.g., ±two feet along the x-axis in the platform's local coordinate system) to capture side surfaces relevant to stair navigation (e.g., banisters or adjacent walls); aggregation of overhead points (e.g., within a specified vertical threshold along the positive y-axis) to detect potential obstructions above the platform's current trajectory (e.g., such as overhanging objects or structures); aggregation of points below the current plane of the platform (e.g., within a vertical range extending along the negative y-axis) to capture surfaces corresponding to stair treads and risers; and transformation of the depth map (e.g., a three-dimensional point cloud) into a reduced representation by extracting stair-specific geometric representations, such as vectors representing stair edges or planes representing individual treads (i.e., to simplify the spatial structure while retaining essential navigation details).

In one variation, the mobile robotic system can: identify a set of tasks (e.g., “navigate to the table” and “extend the arm to retrieve an object on the table”), in the sequence of tasks, specified for concurrent execution by the mobile robotic system; and implement methods and techniques described above to identify a set of secondary controllers (e.g., a walking controller, a manipulation controller) to trigger execution of a set of subroutines corresponding to the set of tasks. The mobile robotic system can then: trigger the depth sensor to generate a depth map of the space; for the first task, compress the depth map according to a first compression template; and for the second task, compress the depth map according to a second compression template. In this variation, the mobile robotic system can uniquely compress a single depth map for both the first and second secondary controllers as the mobile robotic system executes tasks requiring multiple controllers.

Accordingly, the mobile robotic system can selectively process depth maps for different tasks by excluding irrelevant data and extracting task-specific geometric features, such as terrain contours for walking or object edges for manipulation to ensure that each secondary controller receives only the information necessary to effectively execute a corresponding subroutine. Therefore, the mobile robotic system can reduce the complexity of depth maps, enabling rapid data processing while preserving the accuracy required for tasks such as walking, stair climbing, or object retrieval.

### VIII.D. Example Application: Execution of Sequence of Tasks

Generally, the mobile robotic system can process depth maps to identify spatial details relevant to specific tasks, such as detecting obstacles, locating target objects, or analyzing terrain for locomotion. The mobile robotic system can then transmit instructions to secondary controllers responsible for executing these tasks, such as walking to a target location or manipulating an object, and interpret progress and status of these tasks based on real-time feedback from onboard sensors.

More specifically, the mobile robotic system can identify the secondary controller integrated with a subsystem configured to execute the instruction, such as: a motion control subsystem (e.g., actuators and motors enabling locomotion, such as wheels, legs, or tracks); or a manipulation subsystem (e.g., grippers or arms configured to interact with objects in the space).

In one implementation, for a first task (e.g., “navigate to the table”) in the sequence of tasks, the mobile robotic system can implement methods and techniques described above to generate a compressed depth map according to a compression template defined for a first subroutine (e.g., walking) corresponding to the first task. The mobile robotic system can then analyze the compressed depth map to identify task-relevant spatial information, such as: absence of obstructions along the planned path for locomotion; presence and position of a target object for manipulation or retrieval; and environmental features critical to the task, such as stairs, slopes, or proximity to other objects.

For example, for a first task, such as “walk to the stairs,” the mobile robotic system can scan the compressed depth map for presence of obstructions within a forward-facing view of the mobile robotic system. In response to detecting the absence of an obstruction represented in the compressed depth map, the mobile robotic system can: identify a secondary controller (e.g., a walking controller) configured to trigger execution of the first subroutine via a subsystem (e.g., a motion control subsystem) integrated with the secondary controller; transform the first task into an instruction specifying the first subroutine (e.g., walking) and the target location (e.g., “the stairs”) in the spatial map; and transmit the instruction to the secondary controller. Additionally, the mobile robotic system can transform the first task into an instruction specifying specific motion parameters, such as: a stride length (e.g., the distance covered with each step);

a preferred speed (e.g., the walking velocity optimized for balance and energy efficiency); and a turning angle per stride (e.g., the degree of directional change required during each step to align the mobile robotic system with the path to the target).

Additionally, in this implementation, for the first task, the mobile robotic system can receive a signal transmitted by a sensor integrated with the subsystem and representing: a progress indicator (e.g., distance traversed along a planned path measured by odometry sensors, or the percentage of force closure detected by gripper force sensors during object manipulation); and a status indicator (e.g., successful arrival at the target location based on position data from localization sensors, or failure to secure an object based on feedback from proximity or tactile sensors). The mobile robotic system can then interpret the signal to detect the progress and status of a particular task. In response to the status indicator confirming success of the task and the progress indicator confirming satisfactory progress (e.g., relative to a predefined progress threshold), the mobile robotic system can withhold intervention to enable execution of the next task in the sequence of tasks. Alternatively, in response to the status indicator indicating failure of the task, or the progress indicator indicating unsatisfactory progress, the mobile robotic system can trigger generation of a revised sequence of tasks, as described in detail below. The mobile robotic system can then implement methods and techniques described above to transmit instructions, corresponding to each task in the sequence of tasks, to the appropriate secondary controllers to iterate through the sequence until all tasks are successfully executed, or the sequence is terminated based on task status feedback.

Accordingly, the mobile robotic system can: generate compressed depth maps tailored to each task; interpret these maps to detect feasibility of tasks; and monitor execution progress based on signals from integrated sensors, such as odometry data for navigation or force feedback for manipulation. Therefore, the mobile robotic system can efficiently execute complex tasks by integrating depth map analysis, context-aware instructions, and real-time sensor feedback to adaptively manage locomotion, object manipulation, and other tasks.

### VIII.E. Example Application: Iterative Feedback Loop

In one variation, the mobile robotic system can iteratively prompt the task generation model with updated data to identify the appropriate subroutine for immediate execution. In particular, upon receiving a command (or a query), the mobile robotic system can: access a set of state data of the mobile robotic system, the set of state data representing a current task in progress by the mobile robotic system; generate a prompt specifying natural language descriptors of the command (or the query) and the set of state data; transmit the prompt to the task generation model; and receive an output from the task generation model responsive to the prompt, the output specifying a target task for immediate execution by the mobile robotic system based on the command and the set of state data.

In response to the output specifying a target task congruent with the current task, the mobile robotic system can withhold intervention to enable execution of the current task. Alternatively, in response to the output specifying a target task divergent from the current task, the mobile robotic system can: terminate execution of the current task; and initiate the target task (e.g., via a subsystem configured to execute elements of the target task). Furthermore, in response to the output specifying a first target task congruent with the current task and a second target task divergent from the current task, the mobile robotic system can: withhold intervention of the current task; and initiate the second target task.

The mobile robotic system can then iteratively transmit these prompts (e.g., every ten seconds) to the task generation model. Thus, by iteratively passing updated state data to the task generation model, the mobile robotic system dynamically receives decisions about the next appropriate subroutine to execute, thereby eliminating the need to predefine or store the entire sequence of tasks in advance.

### VIII.F. Example Application: Local Replanning

In one variation, in response to detecting failure of a particular task, the mobile robotic system can: detect the current state (e.g., location within the space, progress through the sequence of tasks) of the mobile robotic system (i.e., at a time of the failure); and implement methods and techniques described above to generate and transmit a prompt to a task generation model, the prompt specifying the current state and the initial command. The mobile robotic system can then receive an output from the task generation model responsive to the prompt, the output specifying a sequence of tasks for execution by the mobile robotic system.

The mobile robotic system can then: convert each task, in the revised sequence of tasks, into an actionable instruction; and selectively disseminate the actionable instructions to the secondary controllers. In particular, in response to identifying a subsystem affected by this revised sequence of tasks, the mobile robotic system can transmit a new instruction to the secondary controller that operates the subsystem. Alternatively, in response to identifying a subsystem unaffected by this revised sequence of tasks, the mobile robotic system can withhold intervention to enable execution of the instruction previously sent to the secondary controller that operates the subsystem. Therefore, the mobile robotic system can dynamically adapt to unexpected changes or failures during task execution by generating context-aware replanning tasks, thereby ensuring robust and efficient operation in complex or dynamic environments.

In one example, the mobile robotic system: receives an original sequence of tasks to complete a command to “bring a bottle of water from the refrigerator to the dining table,” the sequence of tasks including: navigating to the refrigerator, retrieving a bottle of water, and returning to the dining table to place the bottle of water on the table. In this example, the mobile robotic system encounters a failure during the execution of the first task, “navigate to the refrigerator.” In particular, based on feedback from motion sensors (e.g., indicating unexpected deviations in odometry readings), the mobile robotic system detects an unexpected obstacle, such as a fallen chair, blocking a planned path.

The mobile robotic system then captures and compiles contextual data at the time of the failure, including: the current location of the mobile robotic system in the spatial map relative to the refrigerator; a set of object data of the obstacle (e.g., the obstacle's position and dimensions detected by the depth sensor); the original command; and the progress through the sequence of tasks, indicating failure during the first step. The mobile robotic system then receives a revised sequence of tasks (i.e., from the task generation model) including: rotate 45 degrees to the left to navigate around the obstacle, proceed forward to the refrigerator along the adjusted path, retrieve a bottle of water from the refrigerator, and return to the dining table to place the bottle of water on the table. The mobile robotic system then analyzes the revised sequence of tasks and identifies a motion control subsystem-configured to execute the “rotate 45 degrees to the left to navigate around the obstacle” task-requiring updated instructions. The primary controller then: converts the updated navigation tasks (i.e., “rotate 45 degrees to the left to navigate around the obstacle,” and “proceed forward to the refrigerator along the adjusted path”) into actionable instructions; and transmits the updated navigation instructions to a walking controller configured to operate the motion control subsystem.

### VIII.G. Example Application: Integration of Spatial Map with Task Execution

In one implementation, the mobile robotic system can integrate the spatial map with the real-time execution of the sequence of tasks by dynamically updating the spatial map based on sensor data and task feedback during execution.

In one example, the mobile robotic system receives a command from the user, such as “Get my jacket from my closet.” The mobile robotic system then implements methods and techniques described above: to generate and transmit a prompt to the task generation model, the prompt specifying a current location of the mobile robotic system (e.g., detected by localization sensors), a current location of the user (e.g., detected by a camera or proximity sensor), natural language descriptors of the jacket (e.g., “jacket,” “coat,”), and natural language descriptors of the target location of the closet; to receive a sequence of tasks responsive to the prompt, such as “walk to the closet,” “look for the jacket,” “retrieve the jacket,” “walk to the entryway,” and “deliver the jacket to the user”; and to execute the first task, such as “walk to the closet.”

Then, for the second task, such as “look for the jacket,” the mobile robotic system implements methods and techniques described above: to execute a scan cycle to generate (or update) the spatial map and the events log to reflect objects, activities, and context proximal the closet; and to query the spatial map for extant spatial records proximal the closet and congruent with the natural language descriptors of the jacket. The mobile robotic system then, in response to the spatial map returning an extant spatial record containing an extant short-term-memory description of object characteristics congruent with the natural language descriptors of the jacket: executes a maneuver (e.g., via a manipulation subsystem) to retrieve the jacket from the closet; and derives and executes a path to locate the mobile robotic system proximal the entryway to deliver the jacket to the user. Therefore, the mobile robotic system can: integrate data in the spatial map with real-time sensor feedback and dynamically update the spatial map to reflect current environmental conditions, thereby ensuring context-aware execution of subroutines to reliably complete tasks in dynamic or unstructured spaces.

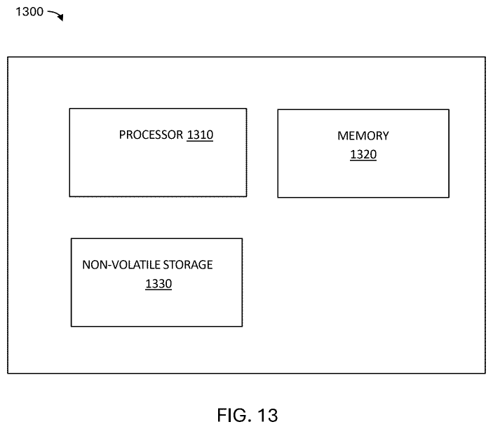

Additionally, FIG. 13 illustrates an illustrative implementation of a special purpose computer system 1300, that may be specially programmed to improve over conventional systems, to be used in connection with any of the embodiments of the disclosure provided herein. The computer system 1300 may include one or more processors 1310 and one or more articles of manufacture that comprise non-transitory computer-readable storage media (e.g., memory 1320 and one or more non-volatile storage media 1330). The processor 1310 may control writing data to and reading data from the memory 1320 and the non-volatile storage device 1330 in any suitable manner. To perform any of the functionality described herein (e.g., secure execution, proxied execution, sandboxed execution, etc.), the processor 1310 may execute one or more processor-executable instructions stored in one or more non-transitory computer-readable storage media (e.g., the memory 1320), which may serve as non-transitory computer-readable storage media storing processor-executable instructions for execution by the processor 1310.

### IX. Additional Details

Having thus described several aspects of at least one embodiment of the technology described herein, it is to be appreciated that various alterations, modifications, and improvements will readily occur to those skilled in the art.

Such alterations, modifications, and improvements are intended to be part of this disclosure, and are intended to be within the spirit and scope of disclosure. Further, though advantages of the technology described herein are indicated, not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be understood that any component or collection of components that perform the functions described above can be generically considered as one or more controllers that control the above-discussed functions. The one or more controllers can be implemented in numerous ways, such as with dedicated hardware or with one or more processors programmed using microcode or software to perform the functions recited above.

In this respect, it should be understood that one implementation of the embodiments of the present invention comprises at least one non-transitory computer-readable storage medium (e.g., a computer memory, a portable memory, a compact disk, etc.) encoded with a computer program (i.e., a plurality of instructions), which, when executed on a processor, performs the above-discussed functions of the embodiments of the present invention. The computer-readable storage medium can be transportable such that the program stored thereon can be loaded onto any computer resource to implement the aspects of the present invention discussed herein. In addition, it should be understood that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

Various examples are methods that can be implemented either on a single computer or a combination of computer-based systems in a distributed network. Method examples are completed in various locations and by one or more systems. For example, and in accordance with the various aspects and embodiments of the invention, IP elements or units include processors (e.g., CPUs, GPUs, or NPUs), random-access memory (RAM—e.g., off-chip dynamic RAM or DRAM), a network interface for wired or wireless connections such as Ethernet, WIFI, 3G, 4G long-term evolution (LTE), 5G, 6G and other wireless interface standard radios. The system may also include various I/O interface devices, as needed for different peripheral devices such as touch screen sensors, geolocation receivers, microphones, speakers, Bluetooth peripherals, and USB devices, such as keyboards and mice, among others. By executing instructions stored in RAM devices, processors perform steps of methods as described herein.

Various aspects of the system described herein may be implemented in a cloud-based database environment, leveraging the scalability and flexibility of distributed computing resources. In this embodiment, the system's components—including the query interface, logical schema layer, storage constraints layer, and document generator—are deployed as microservices within a cloud infrastructure. These microservices communicate via APIs, allowing for independent scaling and updates of each component.

Some embodiments may involve or include one or more machine learning models. In some aspects, the systems and methods described herein may utilize one or more machine learning models to perform various functions and operations. These machine learning models may be implemented on one or more computer systems, which may include local computing devices, remote servers, cloud-based computing platforms, or distributed computing environments. The machine learning models may be trained using various techniques and may be configured to process input data and generate output predictions, classifications, or other results based on learned patterns and relationships.

In some cases, the one or more machine learning models may include supervised learning models, unsupervised learning models, semi-supervised learning models, or reinforcement learning models. The machine learning models may comprise neural networks, decision trees, support vector machines, random forests, gradient boosting machines, or other types of machine learning architectures. In some aspects, the neural networks may include deep learning models such as convolutional neural networks, recurrent neural networks, transformer models, or generative adversarial networks.

The one or more computer systems on which the machine learning models operate may include processors, memory, storage devices, and network interfaces configured to execute the machine learning models and process data. In some aspects, the computer systems may include specialized hardware such as graphics processing units (GPUs), tensor processing units (TPUs), or field-programmable gate arrays (FPGAs) to accelerate machine learning computations. The computer systems may be configured to receive input data from various sources, process the data using the machine learning models, and provide output results to users or other systems.

In some cases, the machine learning models may be trained using training data that includes labeled examples, unlabeled examples, or a combination thereof. The training process may involve adjusting parameters of the machine learning models to minimize a loss function or maximize a performance metric. Once trained, the machine learning models may be deployed on the one or more computer systems to perform inference operations on new input data. The machine learning models may be periodically retrained or updated based on new data or changing conditions to maintain or improve their performance over time.

In some aspects, the systems and methods described herein may involve various types of computer programmatic interfaces that facilitate interaction between users, systems, or components. These interfaces may include application programming interfaces (APIs), web services, software development kits (SDKs), or other programmatic interfaces that enable communication and data exchange between different software components or systems. The programmatic interfaces may be configured to receive requests, process data, and return responses in various formats such as JSON, XML, or other structured data formats. In some cases, the programmatic interfaces may support RESTful architectures, SOAP protocols, GraphQL queries, or other communication protocols to enable interoperability between different systems and platforms.

In some cases, the systems and methods may include graphical user interfaces (GUIs) that provide visual representations and interactive elements for users to interact with the system. The GUIs may include various interface elements such as buttons, menus, forms, sliders, checkboxes, radio buttons, dropdown lists, text fields, or other interactive components that allow users to input data, make selections, or trigger actions. The GUIs may be implemented using various technologies such as web-based interfaces, desktop applications, mobile applications, or other interface frameworks. In some aspects, the GUIs may be designed to be responsive and adaptive to different screen sizes, devices, or user preferences.

In some aspects, the systems and methods may support voice interfaces that enable users to interact with the system using spoken commands or natural language input. The voice interfaces may utilize speech recognition technologies to convert spoken words into text or commands that can be processed by the system. In some cases, the voice interfaces may also include text-to-speech capabilities to provide audible feedback or responses to users. The voice interfaces may be integrated with virtual assistants, smart speakers, mobile devices, or other voice-enabled platforms to provide hands-free interaction with the system.

In some cases, the systems and methods may include heads-up displays (HUDs) or augmented reality interfaces that overlay digital information onto the user's field of view. These interfaces may be implemented using wearable devices such as smart glasses, head-mounted displays, or other augmented reality hardware. The HUDs may present information, notifications, visualizations, or interactive elements in a manner that allows users to access information while maintaining awareness of their physical environment. In some aspects, the HUDs may be used in various applications such as navigation, training, maintenance, or other scenarios where hands-free access to information may be beneficial.

In some aspects, the systems and methods may support other types of interfaces including gesture-based interfaces, haptic interfaces, brain-computer interfaces, or multimodal interfaces that combine multiple input and output modalities. The gesture-based interfaces may utilize cameras, sensors, or other detection technologies to recognize hand movements, body gestures, or other physical actions as input commands. The haptic interfaces may provide tactile feedback through vibrations, force feedback, or other physical sensations to enhance user interaction. The multimodal interfaces may combine visual, auditory, tactile, or other sensory modalities to provide rich and intuitive user experiences. All of these interface types and variations thereof are within the scope of the invention and may be utilized individually or in combination to facilitate user interaction with the systems and methods described herein.

The terms “program” or “software” are used herein in a generic sense to refer to any type of computer code or set of processor-executable instructions that may be employed to program a computer or other processor to implement various aspects of the technology as described above. Additionally, one or more computer programs that when executed perform methods of the technology described herein need not reside on a single computer or processor, but may be distributed in a modular fashion amongst a number of different computers or processors to implement various aspects of the technology described herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Various aspects of the present invention may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments.

Also, the technology described herein may be embodied as a method, of which examples are provided herein including with reference to FIGS. 3, 6, 7A, 7B, 8, 10, 11, and 12. The acts performed as part of any of the methods may be ordered in any suitable way. Accordingly, embodiments may be constructed in which acts are performed in an order different than illustrated, which may include performing some acts simultaneously, even though shown as sequential acts in illustrative embodiments.

The indefinite articles “a” and “an,” as used herein in the specification and in the claims, unless clearly indicated to the contrary, should be understood to mean “at least one.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, for example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term). The phraseology and terminology used herein is for the purpose of description and should not be regarded as limiting. The use of “including,” “comprising,” “having,” “containing,” “involving,” and variations thereof, is meant to encompass the items listed thereafter and additional items.

Unless otherwise specified, the terms “approximately,” “substantially,” and “about” may be used to mean within ±10% of a target value in some embodiments. The terms “approximately,” “substantially” and “about” may include the target value.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

1. A method of processing visual input to identify an object in an environment around a robotic system and classifying the object using a hierarchy of spatiotemporal databases, the method comprises using a processor to:
determine a spatial location of a scene captured by the visual input relative to an environmental map of the environment around the robotic system;
identify an object in the scene captured by the visual input and determine an attribute associated with the identified object;
upon determining the attribute associated with the identified object,
determining one or more semantic tokens associated with the determined attribute;
update a short-term spatiotemporal database to include the identified object as being;
determine whether the identified object matches a stored object associated with a long-term spatiotemporal database, and:
upon determining that the identified object does not match a stored object associated with the long-term spatiotemporal database, updating the long-term spatiotemporal database to include the identified object as being associated; and
upon determining that the identified object matches a stored object associated with the long-term spatiotemporal database, updating the stored object with a position of the identified object and generating a change log entry for the stored object with a time associated with the visual input.

2. The method of claim 1, wherein the change log entry further comprises specifying if an identified person was associated with the change to the stored object.

3. The method of claim 1, wherein the change log entry further comprises, determining that the stored object is associated with one or more additional identified objects.

4. The method of claim 1, wherein the change log entry further comprises, determining that the stored object is associated with a region of the environmental map.

5. The method of claim 1, wherein identifying the object in the scene captured by the visual input comprises analyzing the visual input using a trained machine learning model to identify the object.

6. The method of claim 1, wherein identifying the object in the scene captured by the visual input comprises analyzing features using a trained machine learning model, wherein the features are generated based on the visual input.

7. The method of claim 1, wherein determining the one or more semantic token associated with the identified object comprises analyzing the identified object using a trained machine learning model configured to identify a plurality of semantic tokens associated with an object and to determine values for the plurality of tokens based on the visual input.

8. A system, comprising:
at least one computer hardware processor; and
at least one non-transitory computer-readable storage medium storing processor executable instructions that when executed by the at least one computer hardware processor perform a method of processing visual input to identify an object in an environment around a robotic system and classifying the object using a hierarchy of spatiotemporal databases, the method comprises using a processor to:
determine a spatial location of a scene captured by the visual input relative to an environmental map of the environment around the robotic system;
identify an object in the scene captured by the visual input and determine an attribute associated with the identified object;
upon determining the attribute associated with the identified object, determining one or more semantic tokens associated with the determined attribute;
update a short-term spatiotemporal database to include the identified object as being;
determine whether the identified object matches a stored object associated with a long-term spatiotemporal database, and:
upon determining that the identified object does not match a stored object associated with the long-term spatiotemporal database, updating the long-term spatiotemporal database to include the identified object as being associated; and
upon determining that the identified object matches a stored object associated with the long-term spatiotemporal database, updating the stored object with a position of the identified object and generating a change log entry for the stored object with a time associated with the visual input.

9. The system of claim 8, wherein the change log entry further comprises specifying if an identified person was associated with the change to the stored object.

10. The system of claim 8, wherein the change log entry further comprises, determining that the stored object is associated with one or more additional identified objects.

11. The system of claim 8, wherein the change log entry further comprises, determining that the stored object is associated with a region of the environmental map.

12. The system of claim 8, wherein identifying the object in the scene captured by the visual input comprises analyzing the visual input using a trained machine learning model to identify the object.

13. The system of claim 8, wherein identifying the object in the scene captured by the visual input comprises analyzing features using a trained machine learning model, wherein the features are generated based on the visual input.

14. The system of claim 8, wherein determining the one or more semantic token associated with the identified object comprises analyzing the identified object using a trained machine learning model configured to identify a plurality of semantic tokens associated with an object and to determine values for the plurality of tokens based on the visual input.

15. At least one non-transitory computer-readable storage medium storing processor executable instructions that when executed by at least one computer hardware processor perform a method of processing visual input to identify an object in an environment around a robotic system and classifying the object using a hierarchy of spatiotemporal databases, the method comprises using a processor to:
determine a spatial location of a scene captured by the visual input relative to an environmental map of the environment around the robotic system;
identify an object in the scene captured by the visual input and determine an attribute associated with the identified object;
upon determining the attribute associated with the identified object, determining one or more semantic tokens associated with the determined attribute;
update a short-term spatiotemporal database to include the identified object as being;
determine whether the identified object matches a stored object associated with a long-term spatiotemporal database, and:
upon determining that the identified object does not match a stored object associated with the long-term spatiotemporal database, updating the long-term spatiotemporal database to include the identified object as being associated; and
upon determining that the identified object matches a stored object associated with the long-term spatiotemporal database, updating the stored object with a position of the identified object and generating a change log entry for the stored object with a time associated with the visual input.

16. The at least one non-transitory computer-readable storage medium of claim 15, wherein the change log entry further comprises specifying if an identified person was associated with the change to the stored object.

17. The at least one non-transitory computer-readable storage medium of claim 15, wherein the change log entry further comprises, determining that the stored object is associated with one or more additional identified objects.

18. The at least one non-transitory computer-readable storage medium of claim 15, wherein the change log entry further comprises, determining that the stored object is associated with a region of the environmental map.

19. The at least one non-transitory computer-readable storage medium of claim 15, wherein identifying the object in the scene captured by the visual input comprises analyzing the visual input using a trained machine learning model to identify the object.

20. The at least one non-transitory computer-readable storage medium of claim 15, wherein identifying the object in the scene captured by the visual input comprises analyzing features using a trained machine learning model, wherein the features are generated based on the visual input.
